(19) United States
(12) Patent Application Publication
(10) Pub. No.: US 2004/0006608 A1
(43) Pub. Date: Jan. 8, 2004

(54) Flexible network element interface

(75) Inventors: Chandramouli Swarna, Cincinnati, OH (US); Renjith Ramachandran, Cincinnati, OH (US); Niraj Desai, Union, KY (US); Asha Sebastian, Cincinnati, OH (US); Vijayekkumaran Murugaiah, Kalugumalai (IN); Jayakumar Kuppuswamy, Cincinnati, OH (US)

Correspondence Address: FROST BROWN TODD LLC, 2200 PNC Center, 201 E. Fifth Street, Cincinnati, OH, 45202-4182, US

(73) Assignee: Convergys CMG Utah

(21) Appl. No.: 10/190,728

(22) Filed: Jul. 8, 2002

(51) Int. Cl. G06F 15/177

(52) U.S. Cl. 709/220

(57) ABSTRACT

A mediation system for converged network system for an xSP (i.e., any service provider of Information Technology (IT)/business services) is readily configured to collect revenue related transaction data (usage data) from new network elements by referencing one or more adapters. Rather than being a compiled, validated and distributed component of the mediation system, these adapters may be accessed after fielding the mediation system or created via a network element definition GUI, thereby reducing the lag time in accommodating new types of network elements.

### FIELD OF THE INVENTION

The present invention pertains to a data management system for real-time collecting data, and more particularly, for collecting message- and file-based usage data from one or more collection points (external interfaces) such as wireline/wireless switches, clearinghouses, billing systems, IP network elements like gateways, routers etc, and other network/mediation devices.

### BACKGROUND OF THE INVENTION

Communication service providers in the recent past have represented three different markets: wireless, fixed line (Internet Protocol (IP)/wireline) and cable/broadband. Each service was separately provided through dedicated hardware and software and separately priced. Usage for billing purposes was a straightforward matter of monitoring time of usage, for instance.

Access providers are those service providers that provide IP connectivity between the end subscriber and the Internet, which can be characterized as providing a “communication” role in this value chain. These access providers are already experiencing a shift away from dial-up access to “always-on” broadband connections to homes and businesses. Content providers provide the video, text, voice and data that are communicated by the access providers. These content providers are experiencing a shift from a small number of communication formats to a large variety of formats.

Technological advances and customer demand for integrated access to a variety of voice, video and data services is increasingly causing a convergence in these markets. In particular, varied services such as basic e-mail, internet access, voice-over-IP (voIP), video mail are being provided as bundled service for use over a wide variety integrated devices, such as PCs, wireless phones, personal digital assistants (PDA), and Internet appliances. As used herein, xSPs, are defined as providers of IP-based services: wireless, cable/broadband, Internet Service Providers (ISPs), Application Service Providers (ASPs), wireline and next-generation service providers.

xSPs are beginning to launch multiple services by aggregating content through partnerships with content owners. Being first to market with bundled service packages, these xSPs will be presented with great opportunities and great challenges to woo and win customers by offering new margin-rich services. But in order to retain the customer, win market share, and derive profits for the long term, these xSPs must have customer care and billing services that work in this complex new environment. Thus, once a customer is provisioned, mediation—capturing and measuring usage from different network elements—is the next hurdle in the multi-market, multi-service, multi-business model. Traditionally, all mediation by an xSP tended to be self-contained within that xSP's operation.

As networks increase in complexity and the value of real-time information expands, the ability to quickly and easily manage network changes and multiple formats is growing as well. Acting as the isolation layer, mediation systems such as Real-Time Processing Manager (RPM) advantageously provides the reliable data handling necessary to interface between ever-changing network elements and applications. The RPM enables operators to quickly introduce new services and change existing services. The module simultaneously supports existing network infrastructures as well as evolving infrastructures, enabling billing for events generated using network technologies such as TDMA, CDMA, GSM, GPRS, UMTS, and CDMA2000.

Acting as the communications gateway for the collection of events, the RPM ultimately results in increased revenue for the service provider via accurate and reliable delivery of network usage data. RPM supports high-capacity data collection from multiple networks. It acts as collector, aggregator, reformatter, and distributor, enabling standardized processing of usage information generated in multi-vendor, multi-service networks. The Web-based user interface places more power into the hands of the user, lowering total cost of ownership by enabling the operator to configure and maintain the application regardless of the chosen delivery option. Configurable business rule definition, filtering, duplicate and gap checking, error processing, and other user definable parameters offer maximum flexibility in usage processing. This fully functional, modular application supports multiple market segments and technologies simultaneously, enabling the service provider to have a single, convergent mediation platform upon which to support its business needs. The RPM supports both prepaid and postpaid networks in a single mediation environment, enabling the carrier to provide diverse services to its customers without sacrificing revenue assurance, flexibility, and control. Also, since the RPM serves as a transparent isolation layer between applications and service/network elements, the impact to the systems with which it interfaces is minimal.

Supporting both circuit-switched as well as IP networks, the RPM application provides a simplified and standardized interface for the acquisition of billing data. Its capabilities include: (a) convergent pre-paid and post-paid mediation support; (b) event validation, editing, gap and duplicate checking; (c) error correction (individual and mass); (d) carrier control of event collection processes via GUI/table-driven parameters; (e) event aggregation, reformatting, event correlation, and call assembly; (f) enterprise-specific field validation, business validation, data manipulation rules; (g) filtering and grouping; (h) reformat definition/application; (i) revenue assurance: audits and controls with extensive reporting and analysis; (j) mediation data record search capability; (k) role-based security; (l) multi-standard roamer processing.

Thus, known mediation systems such as RPM have a number of desirable features, such as succeeding in gathering usage data from various types of network elements (NE). However, a specific data handler has to be defined for each type of network element. The specific data handlers are then incorporated into the next version of the mediation system that is distributed to customer xSPs. This incorporation generally requires recompiling the affected computer program modules and testing to validate that the code is operating satisfactorily. Although this has been a generally satisfactory approach, updates to the mediation system to accommodate new network elements are less frequent than what may be preferred by customers.

Consequently, a significant need exists for a network element data handler for a mediation system for a converged mediation network system for xSP customers that is readily updated for new types of network elements.

### BRIEF SUMMARY OF THE INVENTION

The invention overcomes the above-noted and other deficiencies of the prior art by providing a mediation manager that has a parser configured by an adapter so that data type formats of usage data for new types of network elements are readily converted into a standard format. The adapter is accessed by a data handler to configure the parser. Thereby, the mediation manager is updated by a user without having to redesign, compile and retest the mediation manager.

In one aspect of the invention, a method is given for receiving usage data from a collection point that includes a network element that is of a type having a specified data format. The method is performed by creating an adapter to define a new data format, associating the adapter with a type of network element. With the data handler now configured to handle the new network element, the method further includes identifying receiving usage data from a collection point as being from the associated type of network element, and parsing the received usage data message into a standard format by referencing the associated adapter. Thus, an xSP may more readily adapt to rapidly changing technology and types of services, avoiding a lengthy delay and expense of having to procure an updated mediation manager from an application developer.

In another aspect of the invention, an apparatus is described for mediating usage data from a network for use by a billing-related system has a file collector coupled to an operator network to receive usage data from at least one network element. A data handler is configured to convert received usage data from a data type format to a standard format. An adapter includes a network element definition associated with the network element. The network element definition maps the usage data to the standard format. Separating the network element definition and the association with the network element allows a user to download or interactively create the network element definition and to associate it with a network element when a new element is added to a converged network system.

These and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a diagram of a converged network mediation system for providing xSP services wherein a mediation manager consistent with the present invention provides an interface for revenue generating transaction data.

FIG. 2 is a diagram of Flexible Network Element (Flex NE) Interface of the Mediation Manager of FIG. 1.

FIG. 3 is an object-oriented programming (OOP) class diagram for a Flex NE framework implementing the Flex NE Interface of FIG. 2.

FIG. 4 is an OOP class diagram for the Parser utility of the framework of FIG. 3.

FIG. 5 is an OOP class diagram for the Adapter utility of the framework of FIG. 3.

FIG. 6 is an OOP class diagram for an Adapter Manager utility for loading and unloading the Adapter utility of FIG. 5.

FIG. 7 is a diagram for types of Adapter utility, loaded and unloaded by the Adapter Manager utility of FIG. 6, for various types of Network Elements.

FIG. 8 is a sequence diagram of the Flex NE framework of FIG. 3.

FIG. 9 is a sequence diagram of the Flex NE application of the framework of FIG. 8.

FIG. 10 is a sequence diagram for the Parser and Adapter, and Adapter Manager of the Flex NE application of FIG. 9.

FIG. 11 is a sequence diagram for the Adapter Manager of FIG. 10.

FIG. 12 is a hierarchical depiction of the Flex NE GUT for the Flex NE Interface of FIG. 2.

FIG. 13 is mapping script definitions GUT window of the Flex NE GUT of FIG. 12.

FIG. 14 is an attributes window of the mapping script definitions GUT window of FIG. 13.

FIG. 15 is a data type definition window of the mapping script definition GUT window of FIG. 13.

FIG. 16 is an event bypassing window of the mapping script definitions GUT window of FIG. 13.

FIG. 17 is an event mapping window of the mapping script definitions GUT window of FIG. 13.

FIG. 18 is an associate NE mapping script window of the Flex NE GUI of FIG. 12.

FIG. 19 is a diagram of an alternate parser component, for the Flexible Network Interface of FIG. 2, configured for ASN.1 usage data and nested, delimited usage data.

FIGS. 20-21 depict a state diagram for the alternate parser component of FIG. 19.

FIG. 22 depicts a state diagram for the ASN1RecordProcessor component of the alternate parser component of FIG. 20.

FIGS. 23-24 depicts a sequence diagram of the alternate parser component of FIG. 19.

### DETAILED DESCRIPTION OF THE INVENTION

### Mediation Manager

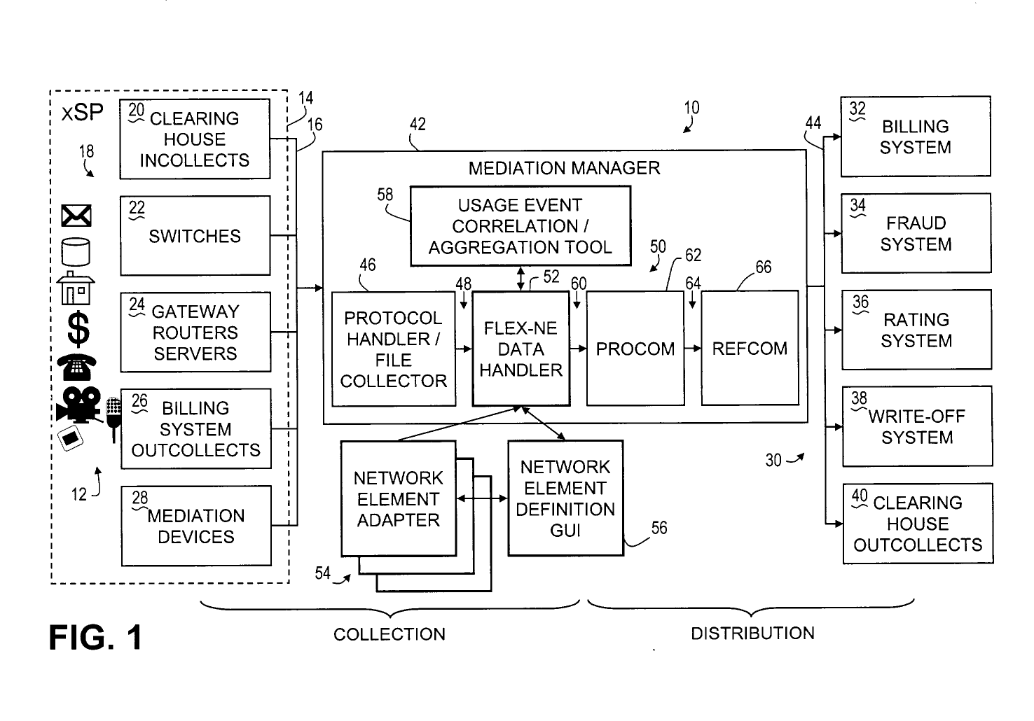

With reference to the Drawings, wherein like numbers refer to like components through the several views, FIG. 1 depicts a converged network mediation system 10 for providing xSP (i.e., any service provider of Information Technology (IT)/business services) content 12 to customers via an xSP operator network 14. Examples of xSP content 12 include e-mail, Internet access, voice-over-IP (voIP), video mail, SMTP/MIME wireless, H.323 SIP data, MPEP Audio/Video, HTTP data, etc. Delivery of the xSP content 14 gives rise to revenue generating transaction data (usage data) 16 that is collected by a plurality of network elements (NEs) 18, such as clearing house incollects 20, switches 22, gateway routers/servers 24, billing system outcollects 26 and mediation devices 28.

Each of these types of NEs 18 tends to reflect different types of xSP content 12 and to be developed by different vendors. Consequently, the usage data 16 is generally raw data in different formats with varying types of information content. The usage data 16 is raw in that it tends to include errors, such as duplicate records and invalid data. The nature of the usage data 16 makes difficult its use by xSP billing-related systems 30, such as a billing system 32, a fraud system 34, a rating system 36, a write-off system 38, and a clearing house outcollect 40. Consequently, a Mediation Manager 42 consistent with the present invention collects the usage data 16 from the NEs 18 and distributes validated, reformatted data 44 to the xSP billing-related systems 30.

The Mediation Manager 42 accomplishes this collection of the message-based and/or file-based usage data 16 with a protocol handler/file collector 46, which receives the usage data 16 from the physical device/external device of the respective NE 18, checking for some common functionality. Thus, received data 48 is thereafter given to a Flexible Network Element Interface (“Flex NE”) 50 that processes the received data 48 into a standardized format, which in the illustrative embodiment is termed ASCII Positional Variable (APV), for further manipulation and processing. The Flex NE data interface 50 includes a Flex NE data handler 52 that is configured by one or more network element adapters 54 for the various data formats of received data 48, corresponding to different types of NEs 18. These adapters 54 may be bundled with the Mediation Manager 42, transmitted to the client for plugging into a fielded Mediation Manager 42, or created via a Network Element Definition Graphical User Interface (GUI) 56.

The Flex NE data handler 52 is readily configured to further process usage data via a usage event correlation/aggregation tool 58, the disclosure of which is presented in a co-pending and commonly-owned application entitled “Flexible Event Correlation Aggregation Tool” to Swama, et al., filed on even date herewith and incorporated by reference in its entirety.

With collection completed by the Flex NE data handler 52, the Mediation Manager 42 transfers collected data 60 to a process manipulator (“Procom”) 62 for field and business validation and data manipulation. Procom 62 performs functions such as locating duplicates or gaps in the collected usage data, range errors in specific fields, and substitutions of data based on specified criteria. Validated data 64 from Procom 62 is then processed by a distribution reformatter (“Refcom”) 66, which reformats and directs portions of the validated data 64 as appropriate to its destination in the xSP billing-related systems 30.

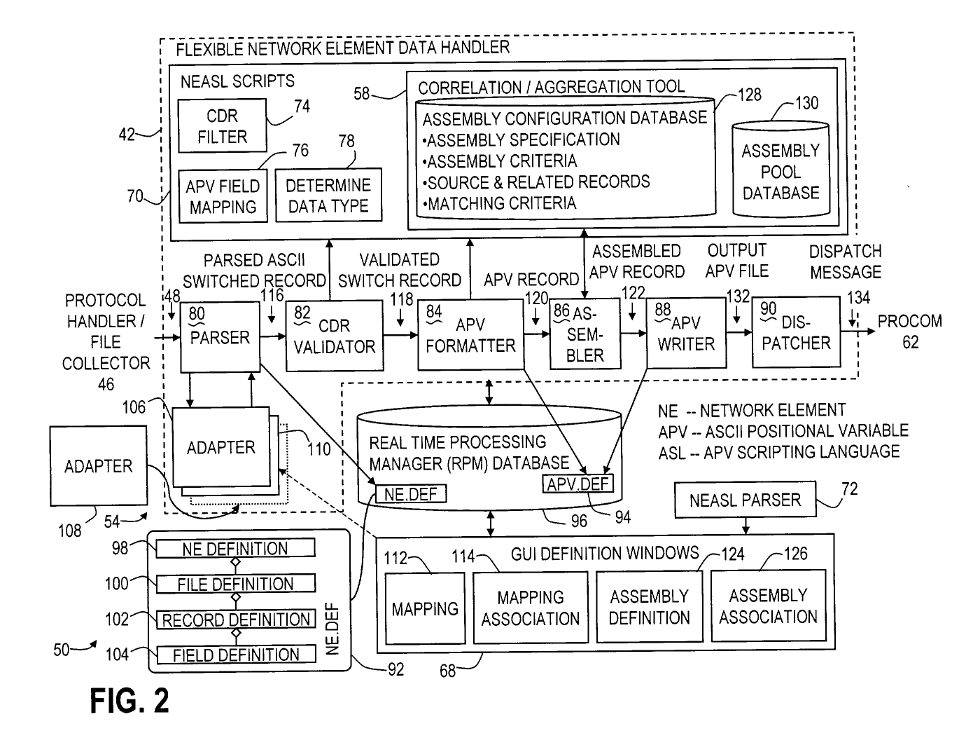

FIG. 2 depicts in greater detail the Flex NE Interface 42 for advantageously completing collection processing of the received data 48 by formatting any type of usage data 16 into APV format using an adaptive and interactive approach. In particular, a Graphical User Interface (GUI), presented as GUI definition windows 68, are interpreted by the Mediation Manager 42 via a precompiled network element APV scripting language (NE ASL) scripts 70, parsed by an NE ASL parser 72. Examples of precompiled NE ASL scripts 70 include a CDR filter script 74 (event bypassing) for determining format errors, an APV field mapping script 76 (event mapping) for converting CDR to APV, and a data type determination script 78 for detecting types such as Voice, Data, Short Message, IP, TAP, CIBER etc.

### NE ASL Scripts

The NE ASL Scripts 70 advantageously enables multiple functions to be performed by the Flex NE Interface 50, including the following: (1) filtering switch records (usage data) based on a expression; (2) identifying the data type (APV type) of switch records; creating APV records dynamically by mapping the switch record fields into newly created subrecords; (3) identifying a type of an APV record in assembly whether it is a Source or Related; (4) assembling the APV records into one or more APV records; and (5) specifying criteria for the assembly as a simple expression using the NEASL.

In some cases the scripting language alone will not be able to satisfy the requirements for more complex computations. In such scenarios simple interface points to the server side processes may be used in the scripts to achieve this functionality. The following abilities are provided by the NE ASL Objects: (1) publishing interface points from the mediation manager processes that the scripting language can make use of; (2) provide the ability for the scripting language to delegate more complex computations as well as table driven operations to Unix processes; and (3) extending the scripting language so that the scripting language can act as an integrator to achieve complex functionality.

The Common Object is a general-purpose object that allows the user to manipulate the MDR. The format to call the Common Object is: “subrecord::field=@Common.method(argument1, argument2, argument3, argument4, argument5)”. The list of methods available in @Common object are shown in Table 1:

TABLE 1

| | | Return | |
|---|---|---|---|
| Method name | Arguments | type | Meaning |
| strcat | string, string | string | Attach first-string |
| | | | argument to |
| | | | second-string |
| | | | argument and |
| | | | returns the |
| | | | attached strings. |
| strlen | String | number | Return the length |
| | | | of the string |
| | | | argument |
| Map Value | string1 map | string | Returns value from |
| | name for | | input string |
| | use, string2 | | that compares |
| | value for | | to a table value. |
| | lookup | | |
| aton | String | number | Take the string |
| | | | values and |
| | | | returns a numeric |
| | | | representation. |
| SysDate | None | datetime | Return the system |
| | | | date and |
| | | | time |
| SysDate- | String | datetime | Return the system |
| AfterN | | | date and time, |
| | | | plus the number |
| | | | of days |
| SubStr | string, start | string | Return a (reads |
| | position | | left to right) |
| | number, length | | sub-string of the |
| | | | string based |
| | | | on the start |
| | | | position and |
| | | | length. Note the |
| | | | first possible |
| | | | position is 0. |
| RevSubstr | Arguments: | string | Return a Reverse |
| | string, start | | (reads right |
| | position number | | to left) sub-string |
| | (start position | | of the string |
| | counts | | based on the start |
| | from right to | | position and |
| | left), length | | length. Note the |
| | (from left to | | first possible |
| | right similar | | position is 0 |
| | to SubStr) | | (start position |
| | | | counts from right |
| | | | to left). |
| strip | Arguments: | String | strip leading characters, |
| | string, string | | trailing characters |
| | (L for leading, | | or both from |
| | T for trailing, | | the string. |
| | B for both), | | |
| | string | | |
| | (″″ default | | |
| | for zeros | | |
| | otherwise | | |
| | specify | | |
| | the character | | |
| | to strip). | | |
| Seconds | seconds | string | return an all |
| 2HHMISS | | | seconds field to a |
| | | | format of HHHMISS |
| | | | format. |
| Random | Number | number | Return a random |
| Number | | | number. For |
| | | | example if 100 |
| | | | is passed, it |
| | | | returns a number |
| | | | 0 through 99 |
| UTC | 5 Character | Number | Returns a second. |
| | String( | | For example |
| | (+/−)HHMM) | | if you pass +1010, |
| | | | it returns |
| | | | 36600 |
| Truncate | String, String | String | Returns the |
| Upto | | | truncated string. |
| | | | For example if you pass |
| | | | “www.ericsson.com” |
| | | | and “.”, it returns “www” |
| Truncate | String, String | String | Returns the |
| After | | | truncated string. |
| | | | For example if you pass |
| | | | www.ericsson.com |
| | | | and “.”, it |
| | | | returns “.eriesson.com” |

The Reference Data object allows a user to use reference data. The format to call the reference Data object is: “@ReferenceData.method (subrecord::field)=“string to compare from reference data lookup”. Note: “field” must be a type of string. The following Table 2 shows the set of methods in ReferenceData:

TABLE 2

| | | Return | |
|---|---|---|---|
| Method name | Arguments | type | Meaning |
| GetNumberType | String | string | Return a string from the SID |
| | | | Range table based on the |
| | | | passed string. |
| GetSID | String | String | Return the SID based on the |
| | | | number passed. |
| GetTLDNFlag | String | Number | Returns the flag. |

A Mapping Script Definition link in a GUI is used to define various Mapping Script Definitions. They are (1) Event Bypassing/Record Filtration; (2) Data Type Definition; and (3) Event Mapping. The Event Bypassing/Record Filtration script is used for determining whether a NE Record is to be included or excluded from further processing:

/* INCLUDE RECORD BYPASSING RULES */

RECORD_FILTRATION

BEGIN

#GUI entry starts from here

SWSUBRECORD::FIELD =“”

#GUI entry starts from here

END

The return value from the Mapping Script Definition script is a Boolean value true or false depending upon the evaluation of expression present as part of the script.

The Data Type Determination script is used for determining the data type of the APV to be produced and can derived from the fields of the NE Record:

BEGIN
#GUI entry starts from here
BEGIN

IF SWSUBRECORD::FIELD = ‘D’

RETURN ‘DATA’

ELSE IF SWSUBRECORD::FIELD =‘V’

RETURN ‘VOICE’

END
#GUI entry ends from here
END

The return from the Mapping Script Definition script is the string given to instruction RETURN to the data type specified for the variable DATA TYPE. The instruction set includes:

BEGIN—END

LOOP—ENDLOOP

IF—ELSE—ENDIF

RETURN

The Event Bypassing/Record Filtration script defines the syntax for mapping the NE Record to APV MDR. The NE ASL scripts 70 have the abilities to create the MDR object for a particular data type and to create a specific sub record instance as seen from the script below. For this the script will have to deal with both the NE and the APV records as well as definitions of NE and APV at compile time. The Event Bypassing/Record Filtration script contains a Header section and a Body section. The Header section on execution returns RPM MDUHeader and the Body section on execution returns a Read/Write ordered set of RPM_MDR's:

APV_MAPPINGSCRIPT
BEGIN
#GUI entry starts from here
HEADERDEF
BEGIN
CREATE HEADER
# HEADER PART
ENDCREATE
END
BODY
BEGIN
#BODY BEGIN
CREATEMDR VOICE

CREATESUBRECORD CORE AS CORE1
CREATESUBRECORD CHARGE AS CHARGE1
CREATESUBRECORD CHARGE AS CHARGE2

/* MAPPING RIITLES */

ENDCREATEMDR
#CREATEMDR END
CREATEMDR DATA

| CREATESUBRECORD DATA AS DATA1 | |
|---|---|
| CREATESUBRECORD CHARGE AS CHARGE1 | |
| # | /* MAPPING RIULES */ |

ENDCREATEMDR
#CREATEMDR END
#BODY END
END
#GUI entry ends here.
END
The Instruction Set for Event Bypassing / Record Filtration script includes
CREATEHEADER
EGIN - END
LOOP - ENDLOOP
IF - ELSE - ENDIF
CREATEMDR - ENDCREATEMDR
CREATESUBRECORD
SETFIELD

### Collection Processing Flow

Returning to FIG. 2, the NEASL Scripts 70 are used to convert usage data 16 to collected data 60. In particular, the conversion processing flow of the Flex NE interface 50 is performed in turn by a parser 80, a Call Detail Record (CDR) validator 82, an APV formatter 84, an assembler 86, an APV writer 88, and a dispatcher 90. Each stage 80-90 of the Flex NE interface 50 is configured by using the NE ASL scripts 70 and by accessing interactively configured definitions for the format of the received data 48, depicted as “ne.def” metadata 92, and an APV definition for an assembled APV record, depicted as “apv.def” metadata 94. The definition files ne.def metadata 92 and apv.def metadata 94 are both stored in a real-time processing manager (RPM) database 96.

The ne.def metadata 92 includes an NE definitions superclass 98 having an aggregation association with file definition 100, which further has an aggregation association with record definition 102, which in turn has an aggregation association with field definition 104.

The parser 80 parses and stores the received data 48 into the format that is specified for the given NE 18 in the ne.def metadata 92. In addition, the parser 80 converts the raw received data 48 into an ASCII format that may be viewed via the GUI definition windows 56. The parser 80 also identifies received data 48 that cannot be decoded/parsed for processing by an error manager.

The parser 80 is configured by the plurality of adapters 54, which may include a bundled adapter 106 that was included with the Flex NE interface 50, a downloaded adapter 108 which is received after installation of the Flex NE interface 50, and an interactively defined adapter 110 produced via the GUI definition window 68, depicted as mapping windows 112 and mapping association windows 114. The parser 80 produces thereby a parsed ASCII switched record 116 to the CDR validator 82.

For a given NE 18, a user specifies the required validation rules for all CDR types via GUI using NE ASL scripts 70. The CDR validator 82 checks the CDR against those specified validation rules, created with the CDR filter scripts 74. If validation succeeds, then the CDR becomes a validated switch record 118 that is further processed. If validation fails, those CDRs is processed by the error manager.

Once a call detail record (CDR) is decoded and validated, APV formatter 84 converts the validated switch record 118 into an APV record 120 in accordance with the associated CDR to APV mapping rules defined in APV field mapping scripts 76. APV is defined and parse in accordance with the apv.def 94. With the usage data 16 now in the standardized format of the APV record 120, the data handler's task is complete. The converted APV record will be processed by the other components such as assembler depending on the configuration.

The assembler 86 correlates and aggregates the APV records 120 into assembled APV records 122 as described in more detail in the aforementioned co-pending application entitled “Flexible Event Correlation Aggregation Tool”. Basically, the assembler 86, in conjunction with the correlation/aggregation tool 58, identifies an assembly related record either by one field or group of fields in the record. Thereafter, two related records are assembled through matching criteria such as checking for one field or checking for multiple fields with multiple expressions. Then, an assembly process involves populating information from one record into another record or creating a new record by populating the information from all of the unassembled APV records 120. Various assembly topologies of assembled APV records 122 are created. One record can be assembled with exactly one record to produce one assembled record. One record can be assembled with many other records within a network element to produce one assembled record. One record can be assembled with many other records within a network element to produce many assembled records. This correlation/aggregation by the assembler 86 is further performed interactively with a user through the GUI definition windows 68, such as assembly definition windows 124 and assembly association windows 126.

Specifically, the assembly definition and association windows 124, 126 define first record identification, other record(s) identification, matching criteria, assembly criteria, assembly topology that are stored in an assembly configuration database 128 as an assembly specification, assembly criteria, source and related records definition, and matching criteria. The unassembled APV records 120 are temporarily stored and manipulated in an assembly pool database 130, which like the assembly configuration database 128, is part of the correlation/aggregation tool 58. Management of the assembly pool database further includes reporting on unmatched APV records 120, reconciliation of assembled APV records 122, and purging of the assembly pool database 130.

The APV writer 88 takes the assembled APV records 122 and writes them into an output APV file 132 in accordance with the apv.def metadata 88. The APV writer 88 has flow controls such as volume based/time based. That is if the output APV records exceeds a threshold value, then the APV Writer can close a given output APV file 132 and open another output APV file 132 for the same assembled APV record 122. The APV dispatcher 84 receives the output APV file 132 and sends a dispatch message 134 to Procom 62 via a comserver for further distribution processing.

### Flexible Network Element Framework

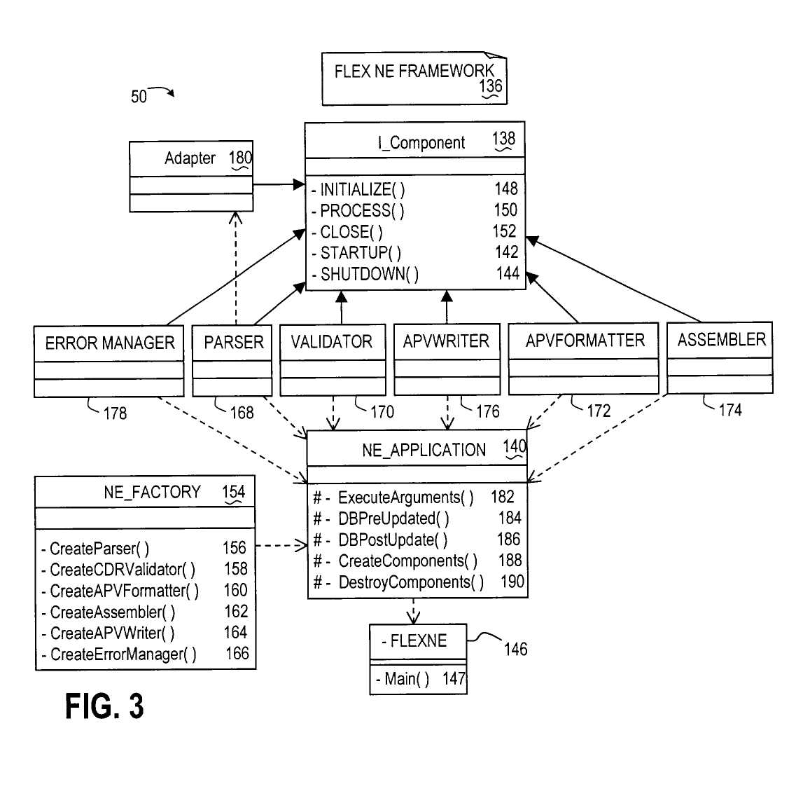

FIG. 3 depicts an illustrative Object Oriented Programming (OOP) class diagram, depicted as Flex NE framework 136, of the Flex NE interface 50 of FIGS. 1 and 2. An I_Component utility 138 contains the basic sequence performed each time received usage data 48 is to be processed. An “NE_Application” class 140 is the controller class for the framework 136. Public startup and shutdown methods 142, 144 are called when bringing up and shutting down a Flex NE instance 146, which has a private Main method 147. Public initialize, process and close methods 148, 150, 152 are invoked for each of the messages received from a File Collector through a CommServer.

An NE Factory utility 154 includes public methods CreateParser( ); CreateCDRValidator( ); CreateAPVFormatter( ); CreateAssembler( ); CreateAPVWriter( ); CreateErrorManager( ) 156-166, which create respectively components Parser, Validator, APVFormatter, Assembler, APVWriter, and ErrorManager 168-178. The Parser uses the Adapter 180 classes that are configured for a network element. The controller class NE_Application 140 includes protected methods ExecuteArguments( ), DBPreUpdated( ), DBPostUpdate( ), CreateComponents( ), and DestroyComponents( ) 182-190.

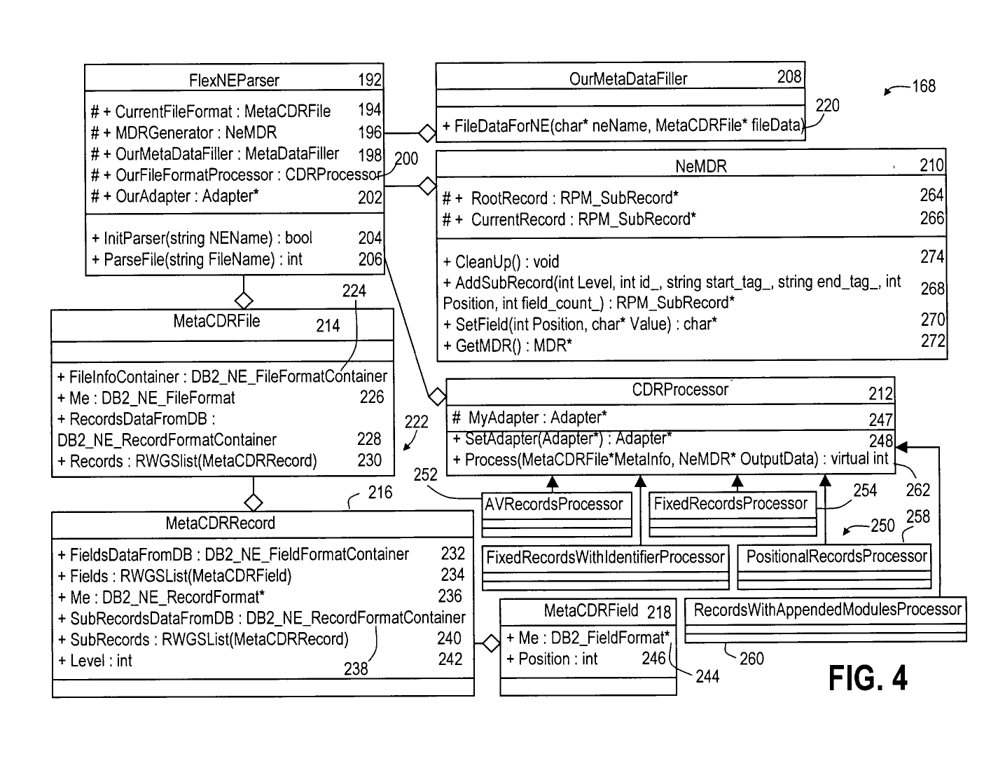

FIG. 4 depicts the Parser 168 of the Flex NE framework 136. In particular, a Flex NE Parser class 192 is an entry point for the functionality of the Parser 168, and includes protected public attributes of CurrentFileFormat:MetaCDRFile; MDRGenerator:NeMDR; OurMetaDataFiler:MetaDataFiler; OurFileFormatProcessor:CDRProcessor; OurAdapter:Adapter*; 194-202 and two public methods InitParser(string NEName):bool and ParseFile(string FileName):int 204, 206. The FlexNEParser class 192 is an assembly class of classes OurMetaDataFiler, NeMDR, CDRProcessor, and MetaCDRFile classes 208-214. The MetaCDRFile class 214 is an assembly class of MetaCDRRecord class 216, which in turn is an assembly class of MetaCDRField class 218.

The OurMetaDataFiler 208 class encapsulates the loading of metadata about the NE 18 for filling into MetaCDRFile class 214, which acts as a container. The MetaCDRRecord class 216 contains the information to process a CDR record, wrapping around CDR record meta information fetched from the RPM database and having information about fields that can come within a CDR record of this type. MetaCDRRecord class 216 has a list of subrecord information loaded from the RPM database and a list of objects created based on this information. The MetaCDRRecord class 216 further has a member level used to create subrecords and to link them together to form a tree of subrecords called a mediation detail record (MDR). The MetaCDRField class 218 has the information to process a CDR field, wrapping around the CDR field meta information fetched from the RPM database. The MetaCDRField class 218 has a member “position” that specifies the position within the field within the record that is used to set field values into the record.

The InitParser( ) method 204 of the Flex NE Parser class 192 is called with the name “string NE Name” of the Network Element 18, which results in a call to FileDataForNE( ) public method 220 of the OurMetaDataFiler class 208. Thereby, the metadata from the RPM database 96 for this particular NE 18 will collected from the ne.def definition file 92 (not shown in FIG. 4) and assembled into metadata call detail record (CDR) layout 222 in accordance with MetaCDRFile class 214.

In particular, the metadata CDR layout 222 includes public methods of the MetaCDRFile class 214:FileinfoContainer:DB2_NE_FileFormatContainer; Me:DB2_NE_FileFormat; RecordsDataFromDB:DB2_NE_RecordFormatContainer; Records:RWGSlist(MetaCDRRecord) 224-230. The CDR layout 222 further includes the public attributes of the MetaCDRRecord class 216: FieldsDataFromDB: DB2_NE_FieldFormatContainer; Fields:RWGSList(MetaCDRField); Me: DB2_NE_RecordFormat*; +SubRecordsDataFromDB: DB2_NE_RecordFormatContainer; SubRecords:RWGSList(MetaCDRRecord); Level: int 232-242. The CDR layout 22 further includes the public attributes of MetaCDRField class 218: Me:DB2_FieldFormat* and Position:int 244, 246.

Based on the resulting metadata CDR layout 222 for the particular NE 18, the Flex NE Parser class 192 instantiates the appropriate version of the CDRProcessor base class 212 to process this layout 222. CDRProcessor class 212 has a protected public attribute “MyAdapter: Adapter 247 and includes SetAdapter(Adapter*): Adapter* method 248 for instantiating an appropriate type of Adapter class 250, depicted as being one of five types: AVRecordsProcessor, FixedRecordsProcessor, FixedRecordswithIdentifierProcessor, PositionalRecordsProcess, and RecordsWithAppendedModulesProcessor classes 252-260. As these names suggest, the FlexNEParser class 92 handles records of five types: (1) records of fixed size; (2) records of fixed size with an identifier; (3) records with appended modules; (4) records of attribute-value pairs; and (5) records with positional values. The CDRProcessor base class 212 has a Process(MetaCDRFile*MetaInfo, NeMDR* OutputData):virtual public method 262 of parameter type int that processes the CDR file and fills the MDR.

In particular, the NeMDR output class 210 for the FlexNEParser class 192. The NeMDR class 210 has protected public attributes RootRecord:RPM_SubRecord* and CurrentRecord:RPM_SubRecord 264, 266. The NeMDR output class 210 calls its “AddSubRecord” method 268 with necessary parameters, including “Level” which is the level member of the MetaCDRRecord Class. Concatenating “switchName”, “RecordId” are used to form Start and End tags. Id is the identification of the record loaded from database. Field count is the count of Field members in Fields container. The NeMDR output class 210 calls “SetField( )” method 270 to set field values of the current subrecord. The NeMDR output class 210 calls “AddCurrentRecordIntoList( )” (not shown) to finish processing a record. The NeMDR output class 210 calls “GetMDR( )” function 272 to get the MDR built by parsing a CDR. This is passed on to the framework for further processing. The NeMDR output class 210 calls “CleanUp( )” function 274 used to reinitialize all the members of NeMDR object.

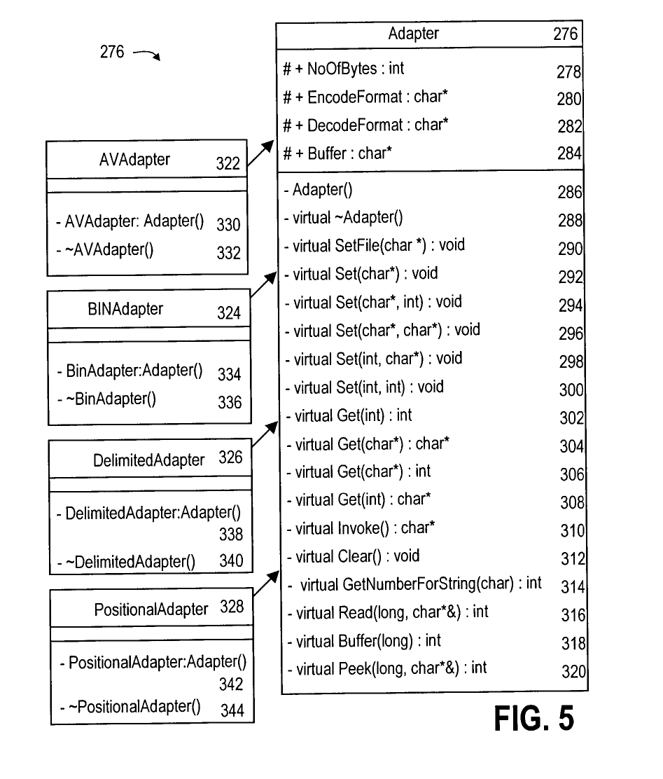

FIG. 5 depicts an Adapter base class 276, used for the appropriate type of Adapter class 250 referenced in FIG. 4. The Adapter class 276 includes four private data members 278-284. NoOfBytes private data member 278 is of int data type, with initial value 0, and is used to store the required number of bytes. EncodeFormat private data member 280 is of char* data type and is used to store the native field encode type. DecodeFormat private data member 282 is of char* data type and is used to store the type of format to be decoded as. Buffer private data member 284 is of char* data type and is used as a buffer for the needs of the parser.

The Adapter base class 276 includes eighteen private member functions 286-320, all of which are abstract. The Adapter( ) function 286 is further defined by the selected type of Adapter 250, as shown by dependent classes AVAdapter, BINAdapter, DelimitedAdapter, and PositionalAdapter 322-328. The AVAdapter class 322 includes AVAdapter private function 330, which has parameter Adapter( ), and includes ˜AVADApter( ) private function 332. The BINAdapter class 324 includes BinAdapter private function 334, which has parameter Adapter( ), and includes ˜BinAdapter( ) private function 336. The DelimitedAdapter class 326 includes DelimitedAdapter private function 338, which has parameter Adapter( ), and includes ˜DelimitedAdaptero private function 340. The Positional Adapter class 328 includes a PositionalAdapter private function 342, which has a parameter Adapter( ), and includes a ˜PositionalAdapter( ) private function 344.

An ˜Adapter( ) private function 288 is a “destructor” of Adapter class and is invoked whenever the instance of an adpter is deleted. Set functions 292-300 set the values as to the number of bytes, encode type, decode type and read this type of variables, etc. The Set functions 290-300 invoke corresponding functions pointed to by the function pointers and which have been loaded from the shared library in the RPM database. The Clear function 312 clears the previous request parameters. The Invoke function 310 performs the actual conversion of the data depending on the parameters sent by the parser and returns the success or failure value back to the parser. The Get functions 302, 304 get data after the Invoke function 310 has been called. The GetNumberForSpring function 314 is a simple mapping function that returns an int value for a specific string. The SetFile function 290 sets the datafile for reading. Subsequent operations are performed on this file until another SetFile function 290 is called or an End Of File (EOF) is encountered in the file. The Buffer function 318 reads from the file and stores it on the Adapter side. The Peek function 320 is to get data of a specified number of bytes, noting that the file pointer points to the previous position only. The Read function 316 gets data of a specified number of bytes.

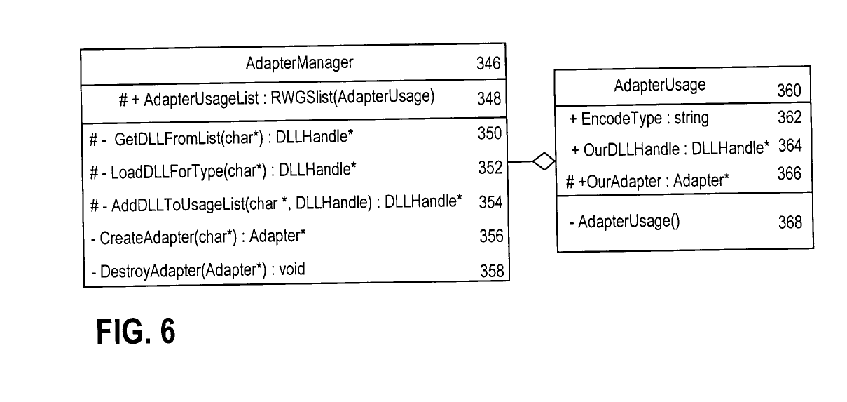

FIG. 6 depicts an AdapterManager class 346 that includes AdapterUsageList private data member 348, which has the data type RWGSlist(AdapterUsage), and is used to contain a list of all dynamic linked libraries (DLLs) of the adapter 250. The AdapterManager class 346 includes methods 350-358. A GetDLLFromList( ) private function 350 has parameter description char* and is used to get a DLL pointer from the RWGSList data member 348. A LoadDLLForType( ) private function 352 has a parameter of char* and is used to load the DLL for the given type. An AddDLLToList( ) private function 354 has a parameter of char* and is used to add the DLL pointer to the list 348. The AdapterManager class 346 includes a CreateAdapter( ) public function 356, which has a parameter description of Char* and which is used to load the shared library of that type and to instantiate the particular type of adapter class. The AdapterManager class 346 also includes a DestroyAdapter( ) public function 358, which has a parameter description of Adapter* and which is used to destroy the object and unload the adapter shared object based on the type of adapter pointer that is passed.

The AdapterManager class 346 is an assembly class for an AdapterUsage class 360, which provides three data members 362-366 and a method 368. EncodeType public data member 362 has string parameter. An OurDLLHandle public data member 364 has a DLLHandle* parameter. An OurAdapter protected data member 366 has an Adapter* parameter. An AdapterUsage( ) private function 368 sets the adapter type for the AdapterManager 346.

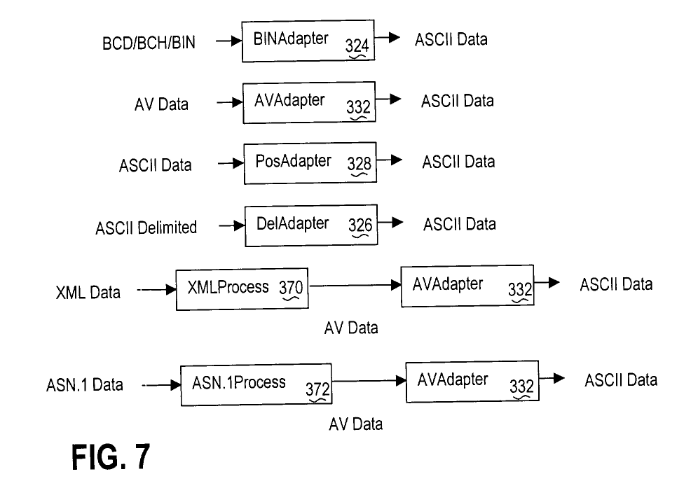

FIG. 7 depicts the action by the AdapterManager class 346 of FIG. 6 in converting CDR data to ASCII (American Standard Code for Information Interchange) format. The BINAdapter class 324 is used BCD (binary coded decimal), BCH (binary coded hexadecimal), BIN (binary), or EBCDIC (Extended Binary Coded Decimal Interchange Code) data. Abstract Syntax Notation 1 (ASN.1) is converted into AV (attribute value pair) data by an XMLProcess 370. Extended Markup Language (XML) data is converted to AV data by an ASN.1 Process 372. AV data, whether originally AV, XML or ASN.1 data, is then converted to ASCII data by the AVAdapter 332. For variable width is specified for ASCII data, then the PosAdapter 328 is used to pass the data to the parser. For other ASCII data, the delimiter character is used and the DelAdapter 326 passes it to the parser.

### Sequence of Collection of Usage Data

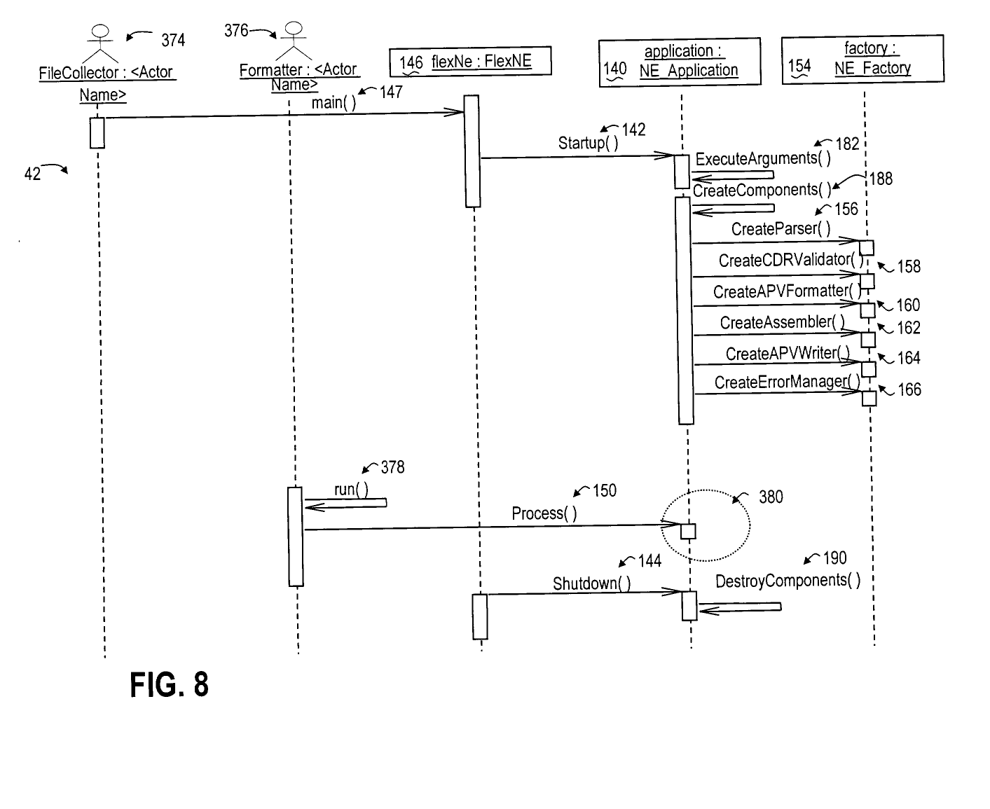

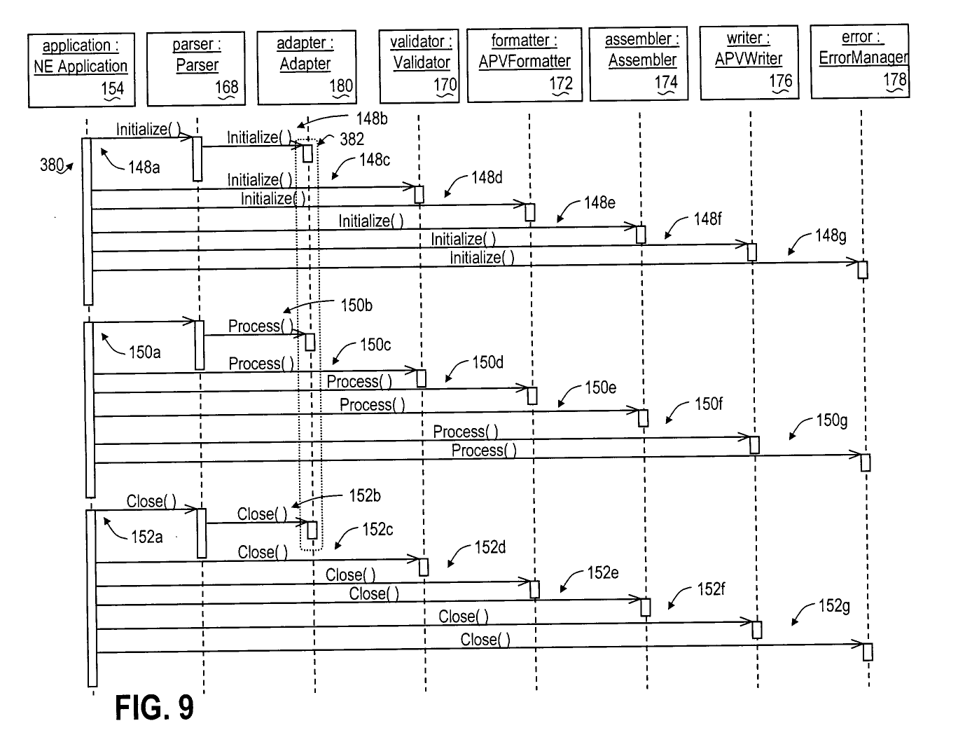

FIGS. 8-11 depict sequences performed by the Flex NE Interface 50 of FIG. 1. In FIG. 8, a “FileCollector” actor 374 and “Formatter” actor 376 perform the function of the protocol handler/file collector 46 of FIG. 1 and FlexNE/Data Handler 52 of FIG. 1 respectively. When FileCollector actor 370 receives data 48 from an NE 18, it sends a message to Formatter actor 376 to process the same. Then Formatter actor 376 invokes at processing block 370, main( ) method 147 of FlexNE class 146 is performed so that Startup( ) method 142 of I_Component class 138 is performed. In particular, ExecuteArgument( ) function 182 is used to initiate the execution of the process for message that is received from the FileCollector actor 370. Then, it invokes CreateComponents( ) methods which is used to instantiate NE Factory class 154, and NE_Application class 140. Thereafter CreateParser( ); CreateCDRValidator( ); CreateAPVFormatter( ); CreateAssembler( ); CreateAPVWriter( ); CreateErrorManager( ) methods 156-166 are used to create respectively components 168-180. With the FileCollector actor 370 have setup the Flex NE Interface 50, then the Formatter actor 376 performs a run function 378 to begin the process of converting call data into mediation data. In particular, the process method 150 of the I_Component class 138 invokes the NE_application 154 to perform the conversion, depicted as 380 and described in more detail in FIG. 9. With the conversion complete, the Shutdown( ) 144 method of Flex NE class 146 invokes the DestroyComponents( ) method 190 of the NE_Application class 140.

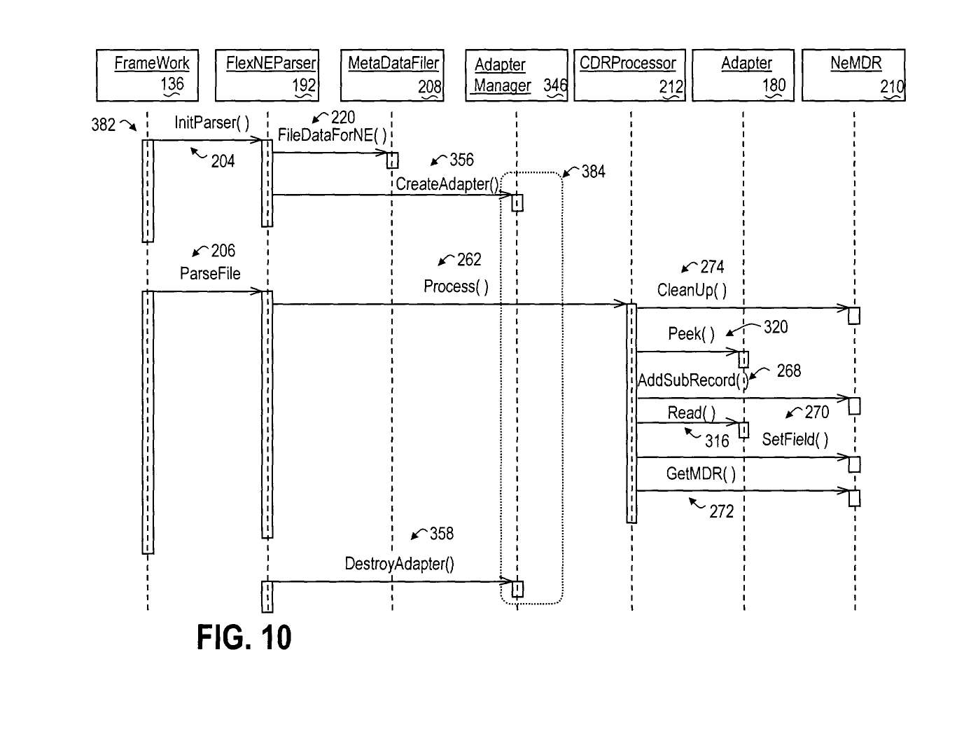

FIG. 9 depicts the sequence 380 of operations performed by the NE_Application class 154 referenced in FIG. 8. The NE_Application class 154 invokes the Initialize function multiple time, depicted as 148a-148g to respectively initialize components 168-178. Then, the NE_Application class 154 invokes the Process function multiple time, depicted as 150a-150g to respectively sequentially process the received data with the initialized components 168-178. Thereafter, the NE_Application class 154 invokes the Close function multiple time, depicted as 152a-152g to respectively close components 168-178. The interaction between the parser 168 and the adapter 180 of functions 148b, 150b and 152c is designated at 382 and depicted in more in FIG. 10.

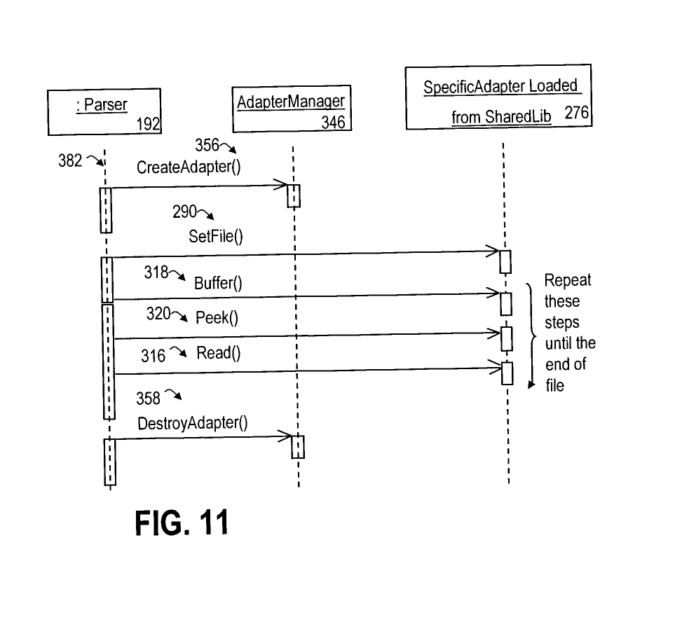

FIG. 10 describes the interaction 382 of the Parser 168 with the appropriate adapter 180, referenced in FIG. 9 at 382. The Flex NE framework 136 initializes the FlexNEParser class 192 with InitParser method 204. The initialized FlexNEParser class 192 stores the received data by using the FileDataForNE( ) function 220 and creates the appropriate adapter appropriate for interpreting the stored data with the CreateAdapter function 356 of the Adapter Manager class 346, depicted at 384 and depicted in more detail in FIG. 11.

With the adapter set up, the framework 136 parsing the stored data by using the ParseFile function 206 of the FlexNE Parser class 192, which in turn invokes the Process method 262 of the CDRProcessor class 262. The CDRProcessor class 212 uses the CleanUp function 274 of the NeMDR class 210 to clean up what is allocated for the input record. Then, the Peek function 320 of Adapter class 180 is used to set the pointer by an offset in the buffer/file stream that the Formatter is processing. The AddSubRecord function 268 of the NeMDR class 210 then creates an instance of input record. Then, the Read function 316 of the Adapter class 180 is used to read the fields from the file buffer/file stream______. Then the SetField function 270 of the NeMDR class 210 is used to populate the values in the created instance of MDR. Thereafter, the GetMDR function 272 of the NeMDR class 210 is used to access the values from MDR object. With the CDR data converted to MDR data, the FlexNEParser class 192 uses the DestroyAdapter function 358 of the Adapter Manager class 346 removes the adapter 180.

### Flexible Network Element Graphical User Interface

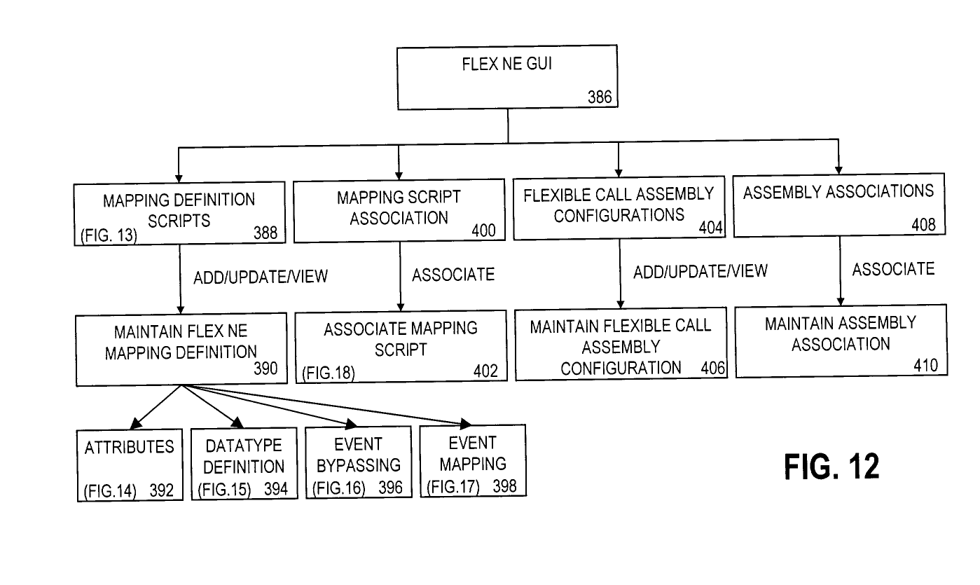

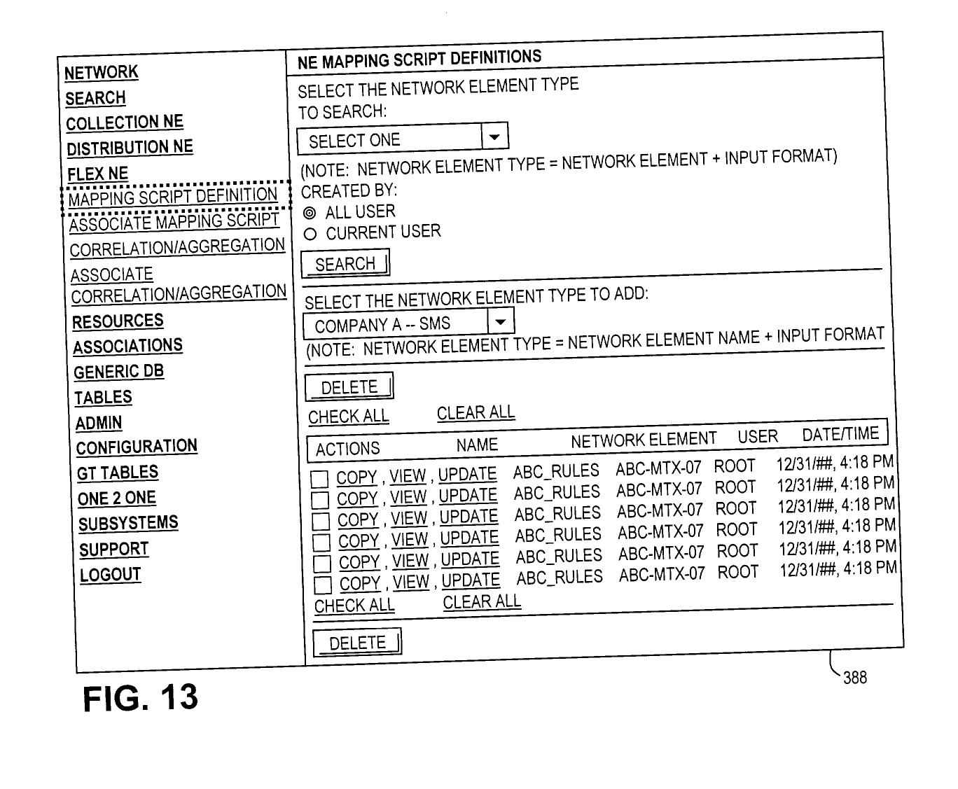

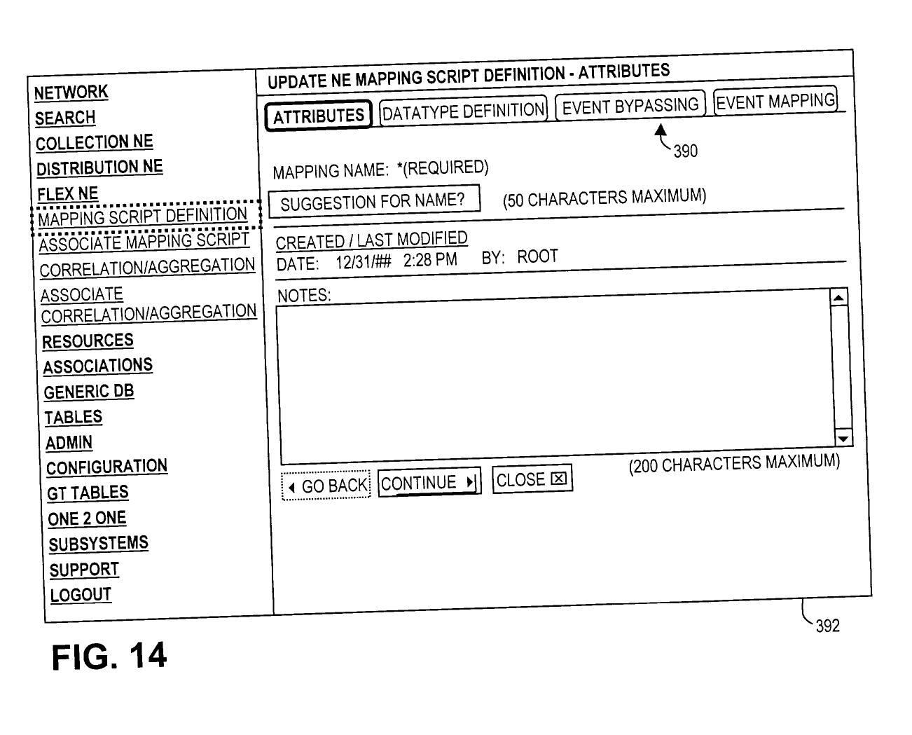

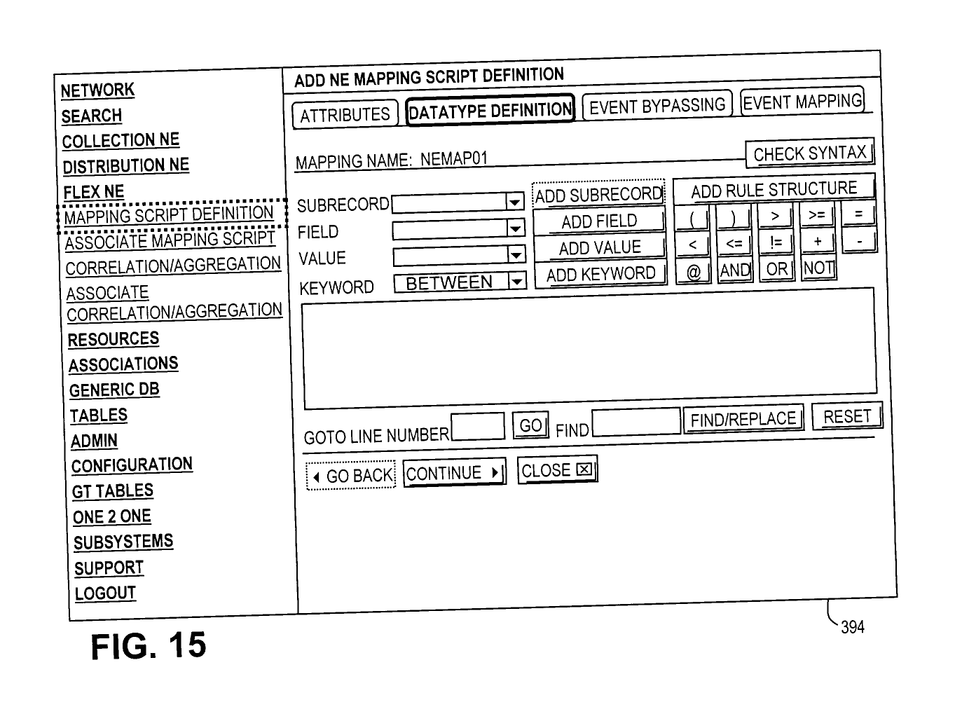

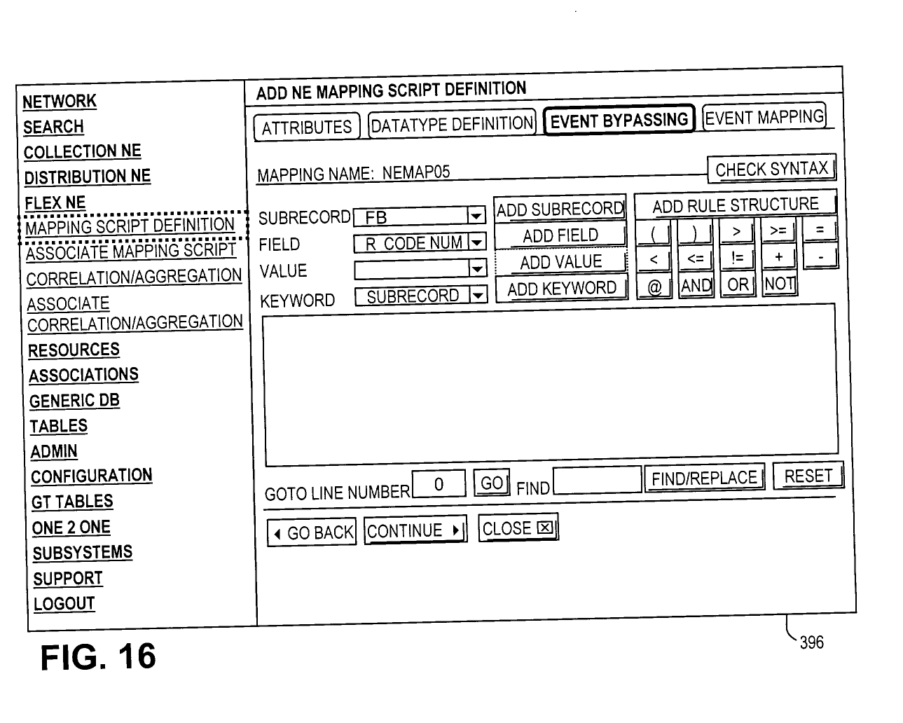

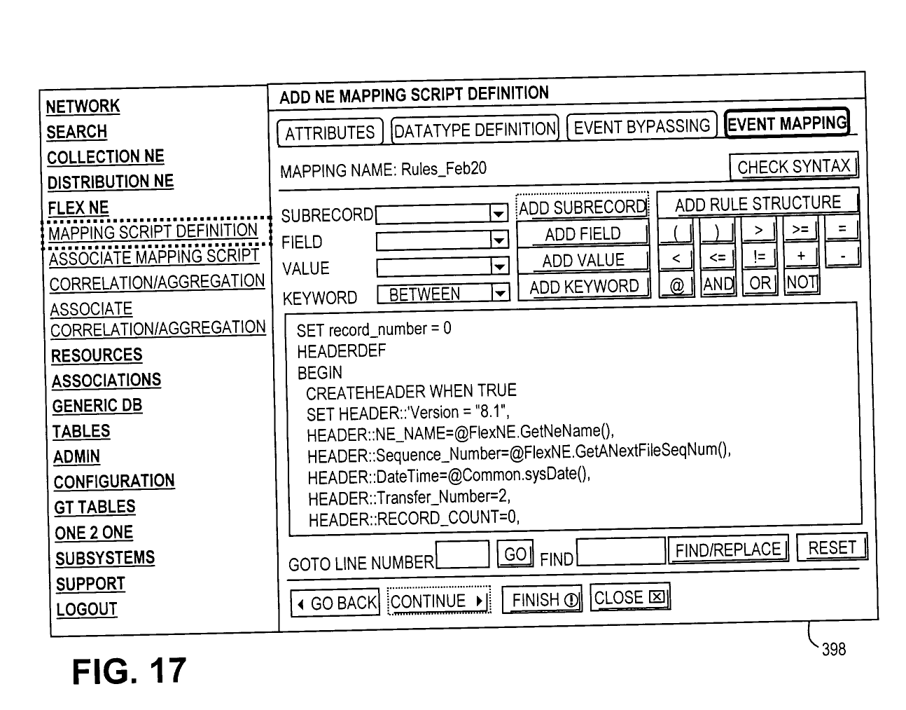

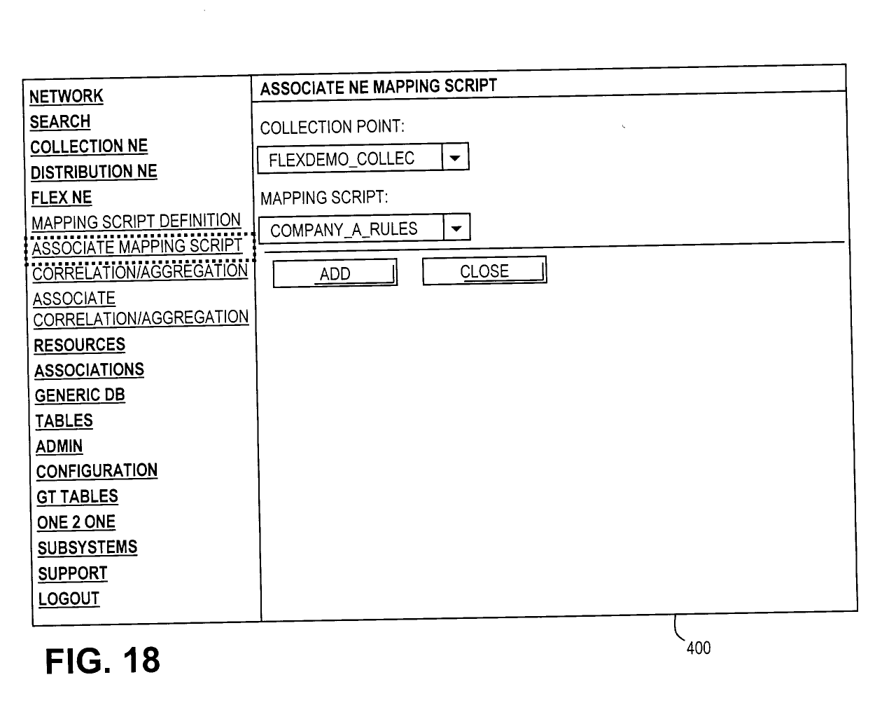

With Reference to FIGS. 12-18, an illustrative Flex NE graphical user interface (GUI) 386 that performs the functions of the NE Definition GUI 56 referenced in FIG. 1. A mapping definition scripts window 388, depicted in more detail in FIG. 13, allows searching for and selecting a pre-existing NE mapping script for copying, viewing or updating. Once one of the pre-existing NE mapping scripts is selected, a maintain Flex NE mapping definition GUI 390 is opened, which is depicted as a window having four tab overlay windows 392-398. An Attributes window 392 allows viewing and modifying the name for the mapping script definition and notes describing the script, as shown in FIG. 14. A Data type Definition window 394 allows a user to define the logic of determining the type of APV that needs to be created. As depicted in FIG. 15, Data Type Definition window provides all the subrecords and fields to the user to define the logic. An Event Bypassing window 396 allows the option of identifying data from an associated NE 18 that need to be bypassed from process stream, as depicted in FIG. 16. An event mapping window 398 allows defining how the fields in the received data is mapped into APV format, as depicted in FIG. 17. Once a script has been selected and modified as desired in FIGS. 13-17, the script is associated with a collection point (a particular NE 18) via an Mapping Script Association window 400, which lists existing associations for the purpose of selecting to associate or disassociate combinations of collection points and mapping scripts. Adding additional associations is done via an Associate NE Mapping Script window 402, depicted in FIG. 18. Thereby, the FlexNE (Formatter) can process the usage when the data from this type of NE 18 is received.

The GUI 386 also allows interactively correlates and assembles call data records to flexibly output usage information for various billing-related activities. A Flexible Call Assembly Configuration window 404 lists established collection points and associated call assembly configurations. From which, a Maintain Flexible Call Assembly Configuration Window 406 allows a user to add, edit and view assembly configurations. Specifically, the Attributes, Source Record, Related Record, Matching Criteria, Assembly (e.g., time-, volume-, or expression-based), and Assembly Specification. With collection points and assembly configurations established, an Assembly Associations window 408 lists already associated collection points and assembly configurations. From which, a Maintain Assembly Associations window 410 allows selecting an assembly configuration to associate with a collection point.

### Alternate Parser Component For ASN.1 And Nested Usage Data

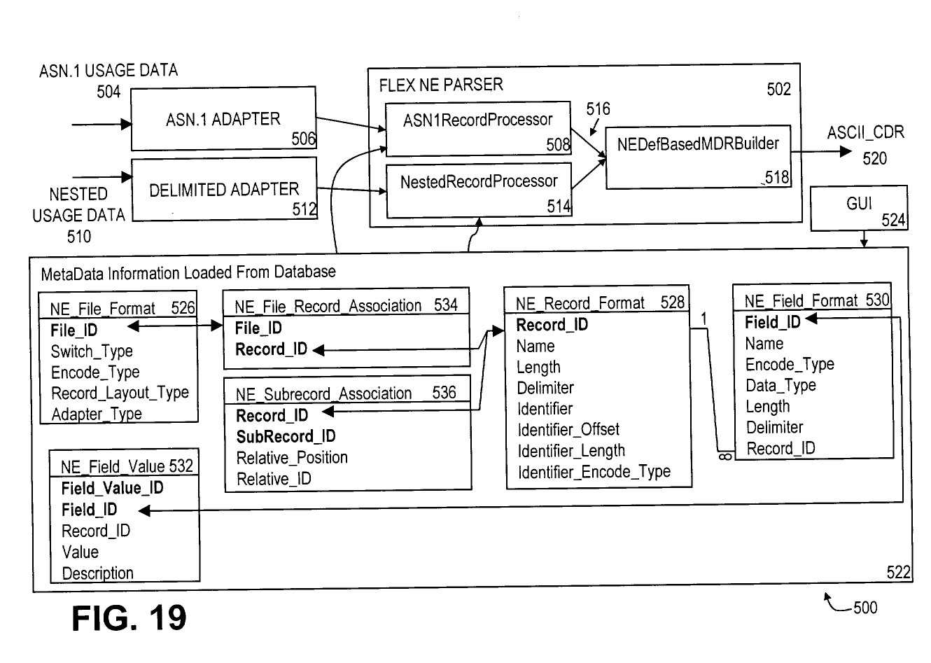

FIG. 19 depicts an alternative Flexible NE Interface 500 for ASN.1 and nested usage data. The alternative way suggests the use of ASN.1 Parser and Delimited adapters that were created to process the ASN.1 usage and nested usage respectively. Although the above-described embodiments advantageously avoid having to draft custom code for new network elements 18, in some instances custom code is required for nested data or ASN.1 data. To the extent possible, the amount of custom code is minimized by having a generic portion, which contains macros that can be reused to fill values and which is incorporated into a Flex NE Parser 502. In particular, ASN.1 usage data 504 is contained by a custom ASN.1 Adapter 506, from which an ASN1RecordProcessor component 508 of the Parser 502 interactively pulls values. Similarly, nested usage data 510 is contained by a delimited adapter 512 from which a NestedRecordProcessor 514 of the Parser 502 interactively pulls values. Decoded usage data 516 from either processor 508, 514 is then formatted by an NEDefBasedMDRBuilder component 518, which replaces the NEMDR class described in FIG. 4, into ASCII_CDR data 520.

The Flex NE Interface 500 handles nested record layouts. In particular, these records are of type Delimited, ASCII, and may be nested, appended, both nested and appended, and may be repeated records. The Flex NE Interface 500 handles ASN.1 record layouts, including repeat record concepts wherein repeat field concepts by treating each repeat field as a sub-record, by having an OSS Compiler (not shown) compile the specific grammar file for the ASN.1 layout. The OSS Compiler is a third party software that is used to compile the ASN.1 grammar and is available from OSS NOKALVA. The ASN1RecordsProcessor class 508 is a derived class of CDRProcessor, which is under Parser, for processing records with an ASN.1 layout. The ASN1RecordProcessor class is written only once to support ASN1 processing in FlexNE. This is capable of interacting with the Adapter in the way specified above. The DelimitedRecordsProcessor class 514 is a derived class of CDRProcessor, which is under Parser, for handling nested/appended layouts.

Meta data information 522 is loaded into classes designed to hold them. The Parser 502 calls the services of the Adapter 506, 512 and gets a field value, using meta data information 522 such as size of records, encoding and decoding methods, size of fields. Thereafter, the Parser 502 re-creates usage data with ASCII values and sends the data to the APV Formatter. The APV Formatter converts them into APV records. Those APV records are then processed by subsequent subcomponents of FlexNE and RPM.

A GUI 524 fills a usage information definition of a particular NE 18 into database tables 526-536 during the configuration phase of that NE 18. The following are the database tables that are used for preloading the Meta data information. Above, the MetaCDRXXX (XXX refers to File, Record, Field) classes were described in such a way that they are wrapped around DB2_NE_XXXX objects. DB2_NE_XXX is a class representation of oracle database table.

When a FlexNE based formatter is run, NE Formatter table (not shown) is accessed to get the correct input type for that collection point. In particular, NE_FORMATTER table gives the SWITCH_NAME and INPUT_FORMAT of a collection point. Using this information, the correct Meta information 522 is loaded from a database from the following tables. NE_SwitchInfo table(not shown) gives SWITCH_TYPE corresponding to a SWITCH_NAME and INPUT_FORMAT combination. NE_File_Format table 526 is queried for file related information including FILE_ID corresponding to the SWITCH_TYPE. NE_Record_Format table 528 is queried for the record information. NE_Field_Format table 530, NE_Field_Value table 532, NE_File_Record_Association table 534 are queried for all the top-level records that can come in that file with FILE_ID. and NE_Record_Field_Association table 536 is queried for the subrecords that can come with a record. All of the dependent libraries to load a shared library are specified in the database table NE_SHAREDLIBRARY_DEPENDECIES (not shown) as a list of libraries. The dependent libraries are loaded before loading a shared library.

NE_FILE_FORMAT table 530 includes the following fields: File_Id field is of type and size Number (4) and has a unique id for this file; it is used to identify to which file a record belongs to by putting this value into all the records that can come within a usage file type. Switch_Type field is of type and size Number (10); It refers to the switch info::switch_Type. Adaptor_Type field is of type and size Varchar2 (100); Based on the information of the correct Adaptor, the file format is loaded for processing the file. libAdaptor_TypeAdaptor.so is the derived filename of the adaptor used to process this file format. Record_Layout_Type field is of type and size Number (3), which is the kind of records that come in that input file type (e.g., (1) Fixed; (2) Fixed With Record Identifier; (3) Variable With Record Identifier; (4) Delimited; (5) AV Pair; and (6) ASN.1).

NE_FILE_RECORD_ASSOCIATION table 534 includes the following fields: File_ID field is of type and size Number (4) and provides the identification of the file to which this record belongs. Record_ID field is of type and size Number (10) and is the unique identifier for a record which is used with fields to identify to which record a field belongs.

NE_RECORD_FORMAT table 528 includes the following fields: Record_ID field is of type and size Number (10) and is the unique identifier for a record which is used with fields to identify to which record a field belongs. Name field is of type and size Varchar2 (200) and is the name of the record. Length field is of type and size Number (20) and describes the length of the record. Delimiter field is of type and size Varchar2 (10) and is the string used as a field delimiter. Identifier field is of type and size Varchar2 (200) and is the string that identifies a record. Identifier_Offset field is of type and size Number (5) and is the offset of the identifier within the record. Identifier_Length field is of type and size Number (5) and is the length of the identifier string in that record. Identifier_Encode_Type field is of type and size Number (4) and is the encoding type of the identifier of the record for decoding this value into ASCII.

NE_SUBRECORD_ASSOCIATION table 536 includes the following fields: Record_ID field is of type and size Number (10) and is the Record Identifier to which the SubRecordID belongs to. Subrecord_ID field is of type and size Number (10) and is the Sub Record Identifier. Relative_Position field is of type and size Number (2) and denotes the position with respect to the Relative_ID. Relative_ID field is of type and size Number (10) and denotes Field ID of Record_ID.

NE_FIELD_FORMAT table 530 includes the following fields: Field_ID field is of type and size Number (30) and is the identification of the field, which is used to uniquely identify this Field Value. Name_field is of type and size Varchar2 (200) and is the name of the field. Record_ID field is of type and size Number (10) and is the identification of the record to which the field belongs. This field value is used to collect all the fields that make up a record. Encode_Type field is of type and size Number (4) and is the type of natural encoding type of this field. This value is used to correctly decode the field into ASCII. Data_Type field is of type and size Varchar (20) and is data type of the field. Length field is of type and size Number (6) and is the length of the field. Delimiter field is of type and size Varchar2 (100) and specifies the field delimiter.

NE_FIELD_VALUE table 532 includes the following fields: Field_Value_ID field is of type and size Number (30) and is the Identification of the record, which is used to uniquely identify this Field Value. Field_ID field is of type and size Number (10) the identification of the field to which this value belongs to. Record_ID field is of type and size Number (10) and is the unique identifier for a record and this is used with fields to identify to which record a field belongs. Value field is of type and size Varchar2 (10) is the data type of the value. Description field is of type and size Varchar2 (100) and is the actual value.

NE_SHAREDLIBRARY_DEPENDENCY table (not shown) includes the following fields: Library_Name field is of type and size Varchar2 (300) and is the name of the Shared Library. Dependency_List field is of type and size Varchar2 (5000) and is the absolute path of all the dependent libraries separated by ‘;’.

Although not depicted in FIG. 19, it will be appreciated that the Flex NE Interface 500 also handles the records with the following layouts: (1) Fixed Size Record Layout; (2) Fixed Size with identifier Record Layout; (3) Records With appended modules; (4) Records of Attribute-Value pairs; and (5) Records with fields delimited.

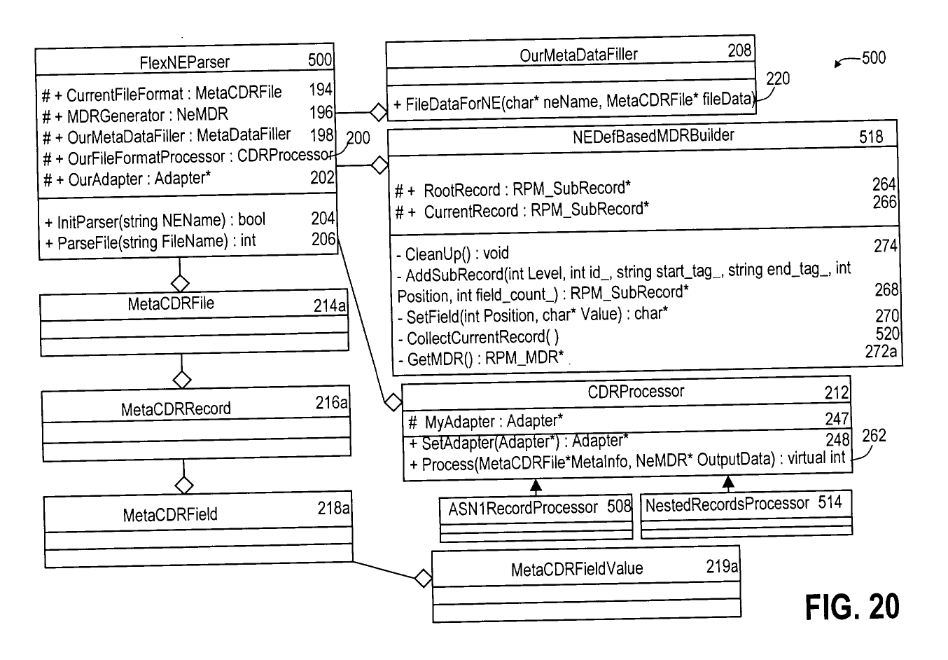

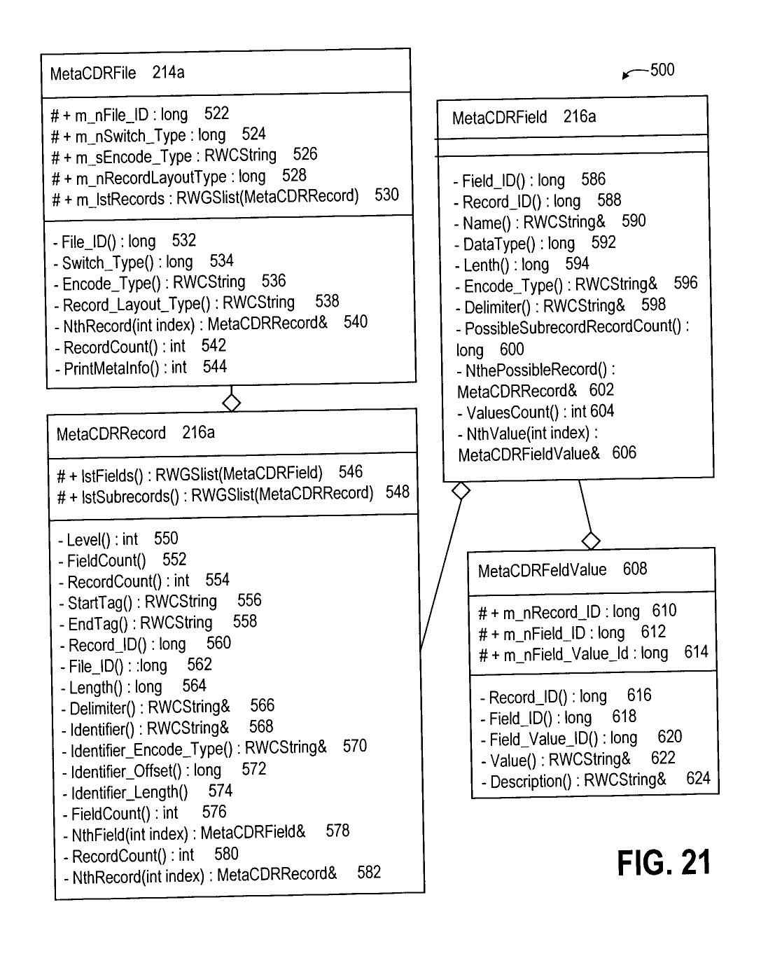

FIGS. 20-21 depict the class structure of the Flex NE Interface 500 of FIG. 19. CDRProcessor 212 is the base class for CDR processor classes 508, 514s and contains an Adapter* 247 that it uses to process records. It has a method “SetAdapter( )” 248 that sets the adapter variable. It has a method “Process( )” 262 that processes the CDR File and fills the MDR.

MetaDataFiller class 208 selects values from various database tables and fills the Meta classes. The logic for filling MetaData classes is isolated into this MetaDataFiller class 208. Any future change in the persistent storage of the Meta data information will result in only changes to this class and not to the MetaCDRXXX Classes. Another notable feature is that all data members are private and ‘get’ functions have been provided. None of the access functions return pointers but instead return references thereby avoiding confusion about the ownership of pointers returned by the functions. MetaDataFiller class 208 is a friend class to all the MetaCDRXXX classes 214a-219a and it only fills the values. All other classes use ‘get’ functions and get only read access to the values in these classes.

MetaDataFiller 208 loads data from the database for a specific NE and fills them into MetaCDRFile class 214a, which is encapsulated into this class. It has a member “FillDataForNE( )” 220 that does that filling of meta data from database for a NE.

The following is the sequence of operations in filling Meta Data information from database: (a) Get Switch_Type for this NE. ‘NE_Formatter’ and ‘NE_Switchinfo’ are the tables that are accessed for this purpose. (b) Get File information using Switch_Type. ‘NE_Field_Format’ table 530 is accessed for this purpose. Switch_Type is used for getting the correct file format. (c) Fill ‘m_{—}1stRecords’ member of MetaCDRFile with information about main records that can come in the file. For this purpose ‘NE_File_Record_association’ and ‘NE_Record_Format’ tables 534, 528 are accessed. (d) Each of those MetaCDRRecord object is filled with information about the fields that form that record. For that purpose ‘NE_Field_Format’ table 530 is accessed. (e) For each of the Fields information about the possible values it can assume is filled into the list named ‘m_{—}1stFieldValues’ in ‘MetaCDRField’. For this purpose ‘NE_Field_Value’ table is accessed. (f) Each of the records have a member ‘m_{—}1stSubrecords’ which will be filled with information about the possible subrecords that can come as nested or appended subrecords to this record. For this purpose ‘NE_Record_Subrecord_Association’ and ‘NE_Record_format’ tables 536, 528 are accessed.

MetaCDRFile class 214a has protected attributes m_nFile_ID:long 522, m_nSwitch_Type:long 524, m_sEncode_Type:RWCString 526, m_nRecordLayoutType:long 528, and m_{—}1stRecords:RWGSlist(MetaCDRRecord) 530. MetaCDRFile class 214 also has private methods File_ID( ):long 532, Switch_Type( ):long 534, Encode_Type( ):RWCString 536, Record_Layout_Type( ): RWCString 538, NthRecord(int index):MetaCDRRecord& 540, RecordCount( ):int 542, and PrintMetaInfo( ):int 544. The MetaCDRFile Class acts as a container of all the information specific to a File format. This will be filled with data loaded from database. MetaDataFiller class does the filling of Meta data into this class from database. It has a container for Meta Data about records loaded from Database and it has a list of MetaCDRRecord objects that were created for each of the Record types.

‘NE_File_Format’ information is filled into this class members. ‘m_{—}1stRecords’ is the list of MetaCDRRecords. These objects are constructed by the information that is fetched both from NE_File_Record_Association and NE_Record_Format tables. NE_File_Record_Association table has Record_Ids of the main records that can come in this file format. Using that Record_Ids other information are fetched from NE_Record_Format about those records. This list size is returned by ‘RecordCount( )’ method of this class. Each of these elements is accessed by ‘NthRecord(int RecordIndex)’ method.

MetaCDRRecord class 216a has protected attributes 1stFields( ): RWGSlist(MetaCDRField) 546 and 1stSubrecords( ):RWGSlist(MetaCDRRecord) 548. MetaCDRRecord class 216a also has private methods Level( ):int 550, FieldCount( ) 552, RecordCount( ):int 554, StartTag( ):RWCString 556, EndTag( ):RWCString 558, -Record_ID( ):long 560, File ID( )::long 562, Length( ):long 564, Delimiter( ):RWCString& 566, Identifier( ):RWCString& 568, Identifier_Encode_Type( ): RWCString& 570, Identifier_Offset( ):long 572, -Identifier_Length( ) 574, FieldCount( ):int 576, NthField(int index): MetaCDRField& 578, RecordCount( ):int 580, NthRecord(int index):MetaCDRRecord& 582. The MetaCDRRecord Class has the information to process a CDR Record. It wraps around the CDR record Meta data information fetched from database. NE_Record_Format is the table source of information. Using the Record_ID field NE_Field_Format table is used to fetch fields that form this Record. Fetched field information is filled into ‘m_{—}1stFields’ list. And ‘FieldCount( )’ method returns the total number fields in the record. ‘NthField( )’ returns the ‘MetaCDRField’ of that field. That object has the field information about that Field. This has a list of subrecord information loaded from database (‘m_{—}1stSubrecords’). And it has a list of MetaCDRRecord objects created based on the information loaded from database. ‘NE_Record_Subrecord_Association’ and ‘NE_Record_Format’ are the two tables used to fill this list. Based on the ‘Record_ID’ all subrecords ‘Record_ID’ are fetched from ‘NE_Record_Subrecord_Association’ and using that ‘NE_Record_Format’ is fetched for details and MetaCDRRecord objects are constructed and filled into m_{—}1stSubrecords. This is done by ‘MetaDataFiller’.

MetaCDRField class 216a has private methods Field_ID( ):long 586, Record_ID( ):long 588, Name( ):RWCString& 590, DataType( ):long 592, Lenth( ):long 594, Encode_Type( ):RWCString& 596, Delimiter( ):RWCString& 598, PossibleSubrecordRecordCount( ):long 600, NthePossibleRecord( ):MetaCDRRecord& 602, ValuesCount( ):int 604, NthValue(int index): MetaCDRFieldValue& 606. The MetaCDRField Class has the information to process a CDR Field. It wraps around the CDR Field Meta information fetched from database. ‘NE_Field_Format’ table is the source of information for this class. It also has a list of ‘MetaCDRFieldValue’ objects that has information about the possible values the field may assume. This list is filled with values from ‘NE_Field_Value’ table. And it has a list of ‘MetaCDRRecord’ objects, which will be filled with record information that can come after this field. This is the list that has values in case of ‘Nested Layout type’.

MetaCDRFeldValue class 608 has protected attributes m_nRecord_ID:long 610, m_nField_ID:long 612, and m_nField_Value_ID( ):long 614. MetaCDRFeldValue class 608 also has private methods Record_ID( ):long 616, Field_ID( ):long 618, Field_Value_ID( ):long 620, Value( ):RWCString& 622, and Description( ): RWCString& 624. The MetaCDRFieldValue class is loaded with possible values that can be assumed by a field. ‘NE_Field Value’ table is the source of information for this class.

NEDefBasedMDRBuilder class 210a includes private methods CollectCurrentRecord( ) 520 and GetMDR( ):RPM_MDR* 272a. NEDefBasedMDRBuilder class is a list that has the details of a particular record and all its parent records. In addition, NEDefBasedMDRBuilder class is the output class into which “RPM_SubRecord”s are added by calling its “AddSubRecord” method with necessary parameters, including “Level” which is the level member of the MetaCDRRecord Class. Concatenating “switchName”, “RecordId” is used to form Start and End tags. Id is the identification of the record loaded from database. Field count is the count of Field members in Fields container. “SetField( )” method is used to set field values of current subrecord. “GetMDR( )” 272a is the function used by Parser to get the MDR built by parsing a CDR for passing on to the Flex NE framework for further processing. “CleanUp( )” 274 is the function used to reinitialize all the members of NEDefBasedMDRBuilder object.

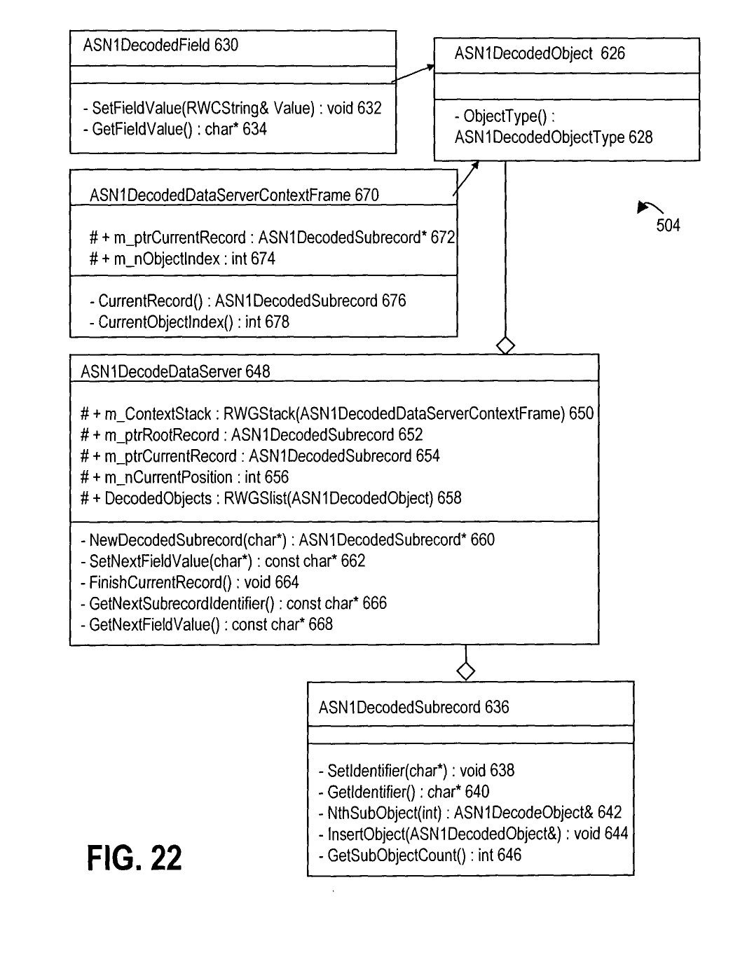

FIG. 22 depicts a class structure for the ASN1RecordProcessor 508 of FIGS. 19-20. ASN1DecodedObject class 626 has private method ObjectType( ): ASN1DecodedObjectType 628. This class is the common base class and it is used to inherit from, by the classes that hold decoded information for Record and Field. It has the virtual method that gives the type of the object, whether a record or a field.

ASN1DecodedField class 630, one of the classes that ASN1DecodedObject class 626 inherits from, has private methods SetFieldValue(RWCString& Value):void 632 and GetFieldValue( ):char* 634, and is used to hold the decoded field values.

ASN1DecodedDataServerContextFrame class 670 has protected attributes m_ptrCurrentRecord:ASN1DecodedSubrecord* 672, and m_nObjectIndex:int 674 and private methods CurrentRecord( ):ASN1DecodedSubrecord 676, and CurrentObjectIndex( ):int 678. This class is used to have the context information needed to get back to the original status after processing a subrecord, and is thus a subclass of ASN1DecodedObject 626. In particular, this class 670 holds the processing status of record. When processing goes into a record an object of this class is created and is filled with values that are necessary to continue processing the current record, once the subrecord into which we are entering. The object is put into a stack. Once the subrecord is processing is over (i.e., all the fields of the record has been retrieved and also the subrecords that belong to that record have also been processed) the context frame is popped back from the stack and processing of the main record continues from the point in which the context changing happened, to process the subrecord. The ‘m_ptrCurrentRecord’ 672 is a pointer to the main record while processing in which a subrecord is encountered. ‘m_nObjectIndex’ 674 is the index of the object with in the main record which is being processed currently. When the context frame is popped back from stack processing continues with the object at the index ‘m_nObjectIndex+1’.

ASN1DecodeDataServer class 648 has protected attributes m_ContextStack: RWGStack(ASN1DecodedDataServerContextFrame) 650, m_ptrRootRecord: ASN1DecodedSubrecord 652, m ptrCurrentRecord:ASN1DecodedSubrecord 654, m_nCurrentPosition:int 656, and DecodedObjects:RWGSlist(ASN1DecodedObject) 658. ASN1DecodeDataServer class 648 also has private methods NewDecodedSubrecord(char*):ASN1DecodedSubrecord* 660, SetNextFieldValue(char*):const char* 662, FinishCurrentRecord( ):void 664, GetNextSubrecordIdentifier( ):const char* 666, and GetNextFieldValue( ):const char* 668. Common data structures are built around the class ‘ASN1DecodedDataServer’ 648. This class is filled in by the custom code and is the interface part of the ASN1Adaptor that fetches the values and give them to the Parser as per the directions of Parser. This class is the heart of the Common code of the ASN1 adapter. Methods of this class are called by both the custom part that will fill the values and the interface part that interacts with the Parser.

ASN1DecodedSubrecord class 636 has private methods SetIdentifier(char*):void 638, GetIdentifier( ):char* 640, NthSubObject(int):ASN1DecodeObject& 642, InsertObject(ASN1DecodedObject&):void 644, and GetSubObjectCount( ):int 646. This class is designed to hold the decoded record information. It has the list of decoded objects, which is used to hold both the field and subrecord information.

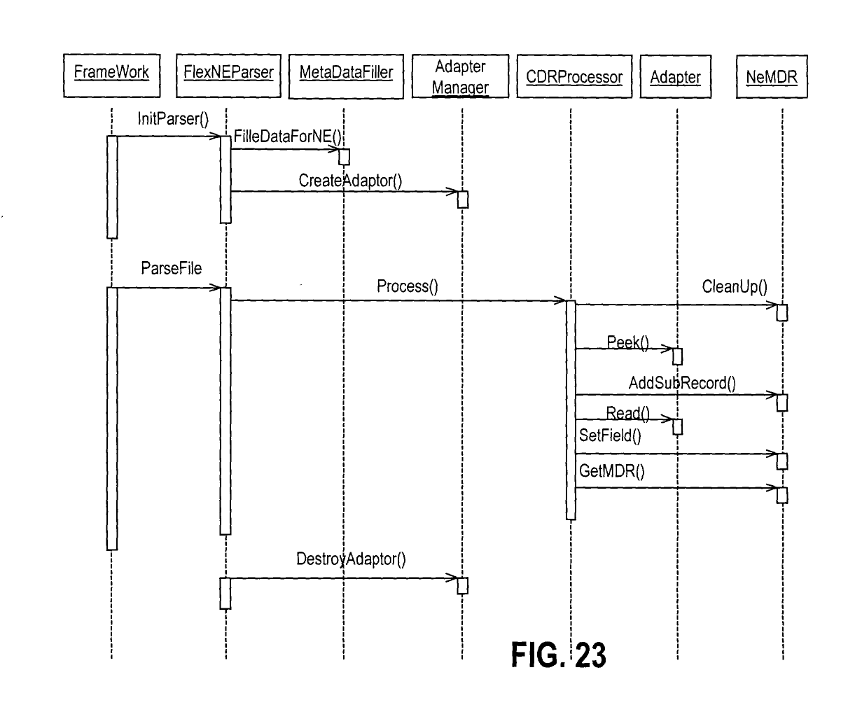

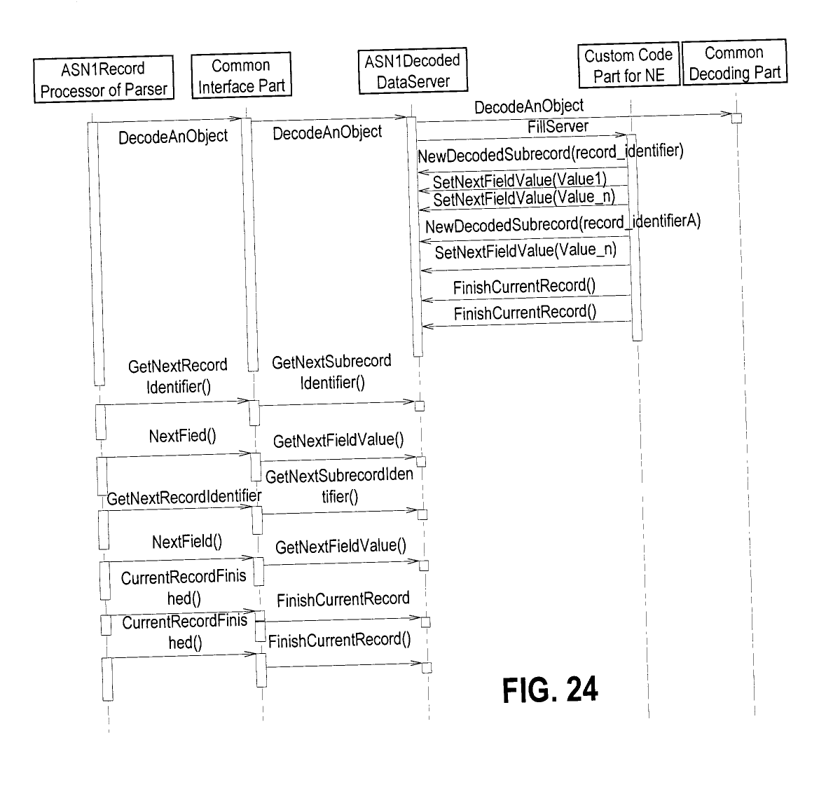

FIG. 23 depicts a sequence of events, or operation for the Flex NE interface 500 of FIGS. 18-22. During the initialization phase, the parser is initialized with the NE Name. Then, MetaDataFiller::FillDataForNEO method is called to fill meta data information from database. The input type correct Adapter is loaded from shared library by calling AdapterManager::CreateAdapter( ) function. During the formatting phase, parsing of the input file is started. The File Name is sent to Adapter. The CDRProcessor::Process( ) is called to process the CDR file. Inside the process function, the processing logic is built-in. For Each of the possible Records, a check is made as to whether it is the next record. This checking may involve peeking into file by using peek operation of Adapter with suitable parameters. For a flat, single type record, it is a straight forward decision to read that record. Given that decision is made that a record is to be read, the Adapter is asked to buffer the number of bytes as needed for that record. Then, Call NeMDR::CleanUp( ) is called to clean up the class to be filled with data. NeMDR::AddSubrecord( ) is called with correct arguments to add an empty RPM_SubRecord into NeMDR. The newly added record is the current record so that subsequent calls to SetField( ) will fill values into that record. NeMDR::GetMDR( ) is called to get the formed MDR object and give the record to the next component of FlexNe when formation of the record is over.

This sequence holds for delimited records and nested layouts. The records may also be repeated. Parser instructs Adapter to read a field. The Adapter's responsibility is to fetch the value for a field and return it back to Parser. After getting the value for a field, it is the responsibility of Parser to process it further. The Parser after reading a field checks whether any subrecord follow this field. If so, then, it identifies which subrecord that follows that field. After identifying the subrecord to be read, it reads the subrecord. After reading all the fields and it frames it together to form a RPM_MDR. By this way, irrespective of Nested/Appended, the records are read in this manner.

An ASN1 based adapter is built whenever a new NE, which generates usage data in ASN1 format, has to be supported. The ASN1 grammar of that usage data is given to OSS ASN1 parser to get header and source files for decoding the usage records. Adapter is built as a wrapper around the OSS generated code for a particular grammar. Adapter reads an ASN1 object and decodes into the C structures provided by OSS generated code. All the simple data type values are converted into ASCII strings. Complex data type (structures) values are converted into subrecords. Repeated fields are also converted into subrecords. After filling into containers, values are given to the Parser depending on the requests from it. The request may just be a request for a field value, or it may be a request for the identifier of the next available subrecord. Since there is no built in identifiers for the decoded values, Identifier are just the name of the records (i.e. the name put into database for the record type into which the structure is converted).

Here it involves doing things that are not normal ‘Read’ or ‘Buffer’ or ‘Peek’, but instead is using the generic methods “Get” “Set” and “Invoke” appropriately. As for the interaction between the Parser and Adapter, values fetching for record fields is an operation driven by Parser. Record Identification is done by Adapter. Other Adapters normally respond passively to the ‘Peek’ messages from Parser. For the ‘request for the Identifier of the next record’, simply the name of the record is given and Parser takes over from that point and starts asking for the fields of the record. Value fetching is done by parser by passing the name of the Field. CDRProcessor asks for the identifier of the following record or subrecord. Based on the returned identifier it decides which record has to be pulled from the ASN1 type Adapter. After the decision is made, it proceeds to request for values from that record. Based on the records identified and values fetched from that records RPM_MDR is built by making requests to NEDefBasedMDRBuilder and passed on to subsequent components of FlexNE for further processing.

### Operation of the Flex NE Interface of a Mediation Manager

In use, a new type of Network Element (NE) 18 is added to an xSP operator network 14. The new NE 18 has a different data format for the usage data that the xSP wishes to use as a revenue generating transaction. A user configures the system for processing the usage from new NE. The configurations include “Defining the record layouts (aka ne.def)” and preloading into database. The pre-loads include a NE definition 98, file definitions 100, record definitions 102, and field definitions 104 to describe the data format from the NE 18. From these definitions the parser 80 of the data handler will be automatically configured to use the appropriate adapter 52 to process the usage from the new NE. Other configurations include writing scripts via GUI using ASL-Data type determination script, Event Bypassing Script, Event Mapping Script. Then, the user associates these scripts via GUI to a collection point.

By virtue of the foregoing, a mediation manager 42 flexibly handles usage data from network elements such as clearing house incollects 20, switches 22, gateway routers servers 24, billing system outcollects, and mediation devices 28 so that usage data 60 is readily converted to a standard format (e.g., ASCII Positional Variable) for further processing.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

What is claimed is:

1. A method of receiving usage data from a collection point including a network element of one of plurality of types, each type having a specified data format, the method comprising:
creating an adapter to define a new data format;
associating a type of network element with the adapter;
identifying receiving usage data from a collection point as being from the associated type of network element; and
parsing the received usage data message into a standard format by referencing the associated adapter.

2. The method of claim 1, wherein creating the adapter to define a new data format further comprises loading a network element definition file.

3. The method of claim 1, wherein creating the adapter to define a new data format further comprises interacting with a user via a graphical user interface to create a network element definition file.

3. The method of claim 3, wherein defining a network element further comprises:
displaying a graphical user interface; and
parsing a scripting language input by a user via the graphical user interface.

4. The method of claim 1, further comprising:
receiving a usage data message from the network element of the first type selected from a group consisting of a switch, a clearing house, a billing system, an external gateway, a router, a server, and a switch mediation device.

5. An apparatus for mediating usage data from a network for use by a billing-related system, comprising:
a file collector coupled to an operator network to receive usage data from at least one network element;
a data handler configured to convert received usage data from a data type format to a standard format; and
at least one adapter including a network element definition associated with the at least one network element, the network element definition including a mapping of the usage data to the standard format.

6. The apparatus of claim 5, further comprising:
a graphical user interface configured to define the mapping of the usage data to the standard format and to associate the mapping to the at least one network element.
